(19) United States
(12) Patent Application Publication
(10) Pub. No.: US 2009/0265060 A1
(43) Pub. Date: Oct. 22, 2009

(54) INFORMATION RECORDING APPARATUS, INFORMATION RECORDING METHOD, INFORMATION RECORDING PROGRAM, AND RECORDING MEDIUM

(75) Inventor: Hiroaki Shibasaki, Tokyo (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 12/092,174

(22) PCT Filed: Oct. 26, 2006
(86) PCT No.: PCT/JP2006/321412

§ 371 Date: Apr. 30, 2008

(30) Foreign Application Priority Data
Oct. 31, 2005 (JP) 2005-316980
Oct. 31, 2005 (JP) 2005-316981

(51) Int. Cl. G06F 7/00

(52) U.S. Cl. 701/35

(57) ABSTRACT

An information recording apparatus executes recording processing for information concerning a traveling state of a mobile object and includes a receiving unit that receives an execution instruction for other processing, a calculating unit, a setting unit, and a control unit. When the receiving unit receives the execution instruction while the recording processing is in progress, the calculating unit calculates a total resource amount required for the recording processing and the other processing, and the setting unit sets a compressibility of the information to be lower than that before receipt of the execution instruction. The control unit controls the recording processing to be executed at the compressibility set by the setting unit.

### TECHNICAL FIELD

The present invention relates to an information recording apparatus, an information recording method, an information recording program, and a recording medium that record information concerning traveling state of a mobile object. However, application of the present invention is not limited to the information recording apparatus, the information recording method, the information recording program, and the recording medium.

### BACKGROUND ART

Conventionally, similar to a flight recorder equipped on an airplane, event data recorders have been proposed that record circumstances surrounding a vehicle in motion. Such event data recorders include a front camera aimed in front of the vehicle, a rear camera aimed behind the vehicle, and a split-image generating unit that synchronizes front and rear images with a reference signal and writes the synchronized images in a predetermined area of an image memory.

Event data recorders correlate vehicle position information and time information to the image memory information, and continuously record the image memory information in a buffer memory. Upon receiving a signal of a value greater than a predetermined value of a shock sensor, the recorded information is transferred to and stored in a storage memory. As a result, a hit-and-run vehicle can be identified in a hit-and-run accident (see, for example, Patent Document 1 below).

Patent Document 1: Japanese Patent Application Laid-open Publication No. 2004-224105

### DISCLOSURE OF INVENTION

### Problem to be Solved by the Invention

However, with the above conventional technique, a problem arises in that though consumers are aware that a merit of purchasing an event data recorder is that, for example, in the event of an accident, relevant evidence can be obtained, consumers are still hesitant as a separate purchase of the onboard device exclusively for event data recording is required. Additionally, another problem arises in that since car space is limited, space may not be available for the installation of the onboard device exclusively for event data recording. Another problem arises in that as various onboard devices, such as a car stereo, are provided in such a small space around the dashboard, an error in operation or misreading of the display may occur easily.

Moreover, in lieu of an onboard device exclusively for event data recording, when another onboard device is allocated an event data recording function in addition to other functions, the load of the processor of the onboard device might increase, and the event data recording function might not be simultaneously executed with the other functions. In this case, the onboard device switches between the event data recording function and the other functions, resulting in fragmented event data recording. As a result, another problem arises in that the circumstances at the time of a traffic accident cannot be always recorded, and a primary object of the event data recorder cannot be achieved.

### MEANS FOR SOLVING PROBLEM

To solve the above problems and achieve the object, an information recording apparatus according to an invention of claim 1 executes recording processing for information concerning a traveling state of a mobile object and includes a receiving unit that receives an execution instruction for other processing excluding the recording processing; a setting unit that, when the receiving unit receives the execution instruction for the other processing during execution of the recording processing, sets a compressibility of the information concerning the traveling state to be lower than that before the execution instruction for the other processing; and a control unit that controls the recording processing to be executed at the compressibility set by the setting unit.

An information recording apparatus according to the invention of claim 4 executes recording processing for information concerning a traveling state of a mobile object using a codec selected from among a plurality of codecs that are processing algorithms requiring different resource amounts and includes a receiving unit that receives an execution instruction for other processing excluding the recording processing; a calculating unit that calculates, when the receiving unit receives the execution instruction for the other processing during execution of the recording processing, a total resource amount that is a sum of a resource amount required for the codec currently used for executing the recording processing and a resource amount required for executing the other processing; a setting unit that sets, based on the total resource amount calculated by the calculating unit, a codec to be used during execution of the other processing; and a control unit that controls the recording processing to be executed using the codec set by the setting unit.

An information recording apparatus according to the invention of claim 8 executes recording processing for information concerning a traveling state of a mobile object and includes a receiving unit that receives an execution instruction for other processing excluding the recording processing; a setting unit that, when the receiving unit receives the execution instruction for the other processing during execution of the recording processing, sets a compressibility of the information concerning the traveling state to be higher than that before the execution instruction for the other processing; and a control unit that controls the recording processing to be executed at the compressibility set by the setting unit.

An information recording apparatus according to the invention of claim 13 executes recording processing for information concerning a traveling state of a mobile object and includes a receiving unit that receives an execution instruction for other processing excluding the recording processing; a setting unit that, when the receiving unit receives the execution instruction for the other processing during execution of the recording processing, sets a record retaining period for the information concerning the traveling state to be shorter than that before the execution instruction for the other processing; and a control unit that controls the recording processing to be executed with the record retaining period set by the setting unit.

An information recording method according to the invention of claim 18 is for recording processing for information concerning a traveling state of a mobile object and includes a receiving step of receiving an execution instruction for other processing excluding the recording processing; a setting step of setting, when at the receiving step the execution instruction for the other processing is received while the recording processing is in progress, a compressibility of the information concerning the traveling state to be lower than that before the execution instruction for the other processing; and a control step of controlling the recording processing to be executed at the compressibility set at the setting step.

An information recording method according to the invention of claim 19 is for executing recording processing for information concerning a traveling state of a mobile object using a codec selected from among a plurality of codecs that are processing algorithms requiring different resource amounts. The information recording method includes a receiving step of receiving an execution instruction for other processing excluding the recording processing; a calculating step of calculating, when at the receiving step the execution instruction for the other processing is received while the recording processing is in progress, a total resource amount that is a sum of a resource amount required for the codec currently used for execution of the recording processing and a resource amount required for execution of the other processing; a setting step of setting a codec used for executing the other processing based on the total resource amount calculated at the calculating step; and a control step of controlling the recording processing to be executed using the codec set at the setting step.

An information recording method according to the invention of claim 20 is for executing recording processing for information concerning a traveling state of a mobile object and includes a receiving step of receiving an execution instruction for other processing excluding the recording processing; a setting step of setting, when at the receiving step the execution instruction for the other processing is received while the recording processing is in progress, a compressibility of the information concerning the traveling state to be higher than that before the execution instruction for the other processing; and a control step of controlling the recording processing to be executed at the compressibility set at the setting step.

An information recording method according to the invention of claim 21 is for executing recording processing for information concerning a traveling state of a mobile object and includes a receiving step of receiving an execution instruction for other processing excluding the recording processing; a setting step of setting, when at the receiving step the execution instruction for the other processing is received while the recording processing is in progress, a record retaining period for the information concerning the traveling state to be shorter than that before the execution instruction for the other processing; and a control step of controlling the recording processing to be executed with the record retaining period set at the setting step.

An information recording program according to the invention of claim 22 causes a computer to execute the information recording method according to any one of claims 18 to 21.

A recording medium according to the invention of claim 23 is a computer-readable recording medium storing therein the information recording program according to claim 22.

### BRIEF DESCRIPTION OF DRAWINGS

FIG. 1 is a block diagram of a functional configuration of an information recording apparatus according to embodiment 1;

FIG. 2 is a flowchart of a recording process for changing a compressibility of information to be recorded;

FIG. 3 is a flowchart of a recording process for changing a codec used for recording processing;

FIG. 4 is an explanatory diagram of a vicinity of a dashboard of a vehicle in which a navigation apparatus is equipped;

FIG. 5 is a block diagram of a hardware configuration of the navigation apparatus;

FIG. 6 is a chart of examples of required resources according to compressibility;

FIG. 7 is a chart of examples of required resources according to function;

FIG. 8 is a flowchart of a compressibility switch process executed by the navigation apparatus;

FIG. 9 is a flowchart of the compressibility switch process executed by the navigation apparatus;

FIG. 10 is a chart of examples of required resources according to codec;

FIG. 11 is a chart of examples of required resources according to function;

FIG. 12 is a flowchart of a codec switch process executed by the navigation apparatus;

FIG. 13 is a flowchart of the codec switch process executed by the navigation apparatus;

FIG. 14 is a block diagram of a functional configuration of an information recording apparatus according to embodiment 2;

FIG. 15 is a flowchart of a recording process for changing a compressibility of information to be recorded;

FIG. 16 is a chart of examples of required memory amounts according to compressibility;

FIG. 17 is a chart of examples of required memory amounts according to function;

FIG. 18 is a flowchart of a compressibility change process executed by a navigation apparatus;

FIG. 19 is a flowchart of the compressibility change process executed by the navigation apparatus;

FIG. 20 is a chart of examples of required memory amounts according to data storing intervals;

FIG. 21 is a chart of examples of required memory amounts according to function;

FIG. 22 is a flowchart of a data-storing-interval change process executed by the navigation apparatus; and

FIG. 23 is the flowchart of the data-storing-interval change process executed by the navigation apparatus.

### EXPLANATIONS OF LETTERS OR NUMERALS

100, 1400 information recording apparatus
101, 1401 receiving unit
102, 1402 setting unit
103, 1403 control unit
104, 1404 calculating unit
105, 1405 judging unit

### BEST MODE(S) FOR CARRYING OUT THE INVENTION

With reference to the accompanying drawings, exemplary embodiments of the information recording apparatus, the information recording method, the information recording program, and the recording medium according to the present invention are explained in detail below.

### Embodiment 1

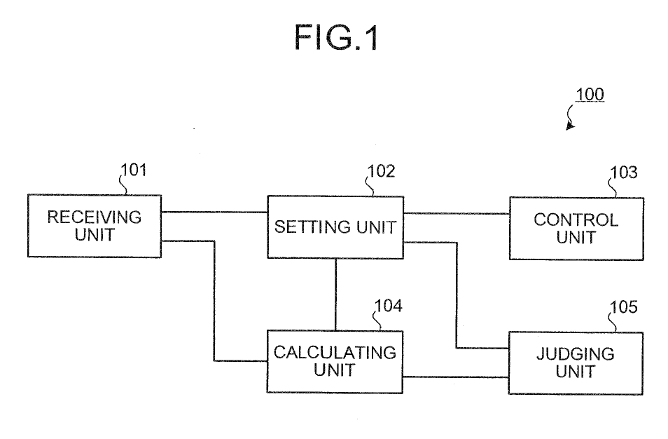

A functional configuration of an information recording apparatus 100 according to embodiment 1 is explained. FIG. 1 is a block diagram of a functional configuration of the information recording apparatus according to embodiment 1. The information recording apparatus 100 includes a receiving unit 101, a setting unit 102, a control unit 103, a calculating unit 104, and a judging unit 105.

For example, the information recording apparatus 100 is provided in a mobile object such as a vehicle, and records information concerning a traveling state of the mobile object. The information concerning the traveling state includes travel route information of the mobile object (such as a transit point and a transit time), velocity information, images and sounds of the environs through which the mobile object travels. For example, the information recording apparatus 100 may record the information concerning the traveling state continuously from a travel start time to a travel end time of the mobile object, only for a designated interval, or at a given interval.

The information recording apparatus 100 compresses and records the information concerning the traveling state. The information concerning the traveling state includes images or sounds of a relatively large data volume, which increases when the information concerning the traveling state is recorded continuously. Therefore, the information recording apparatus 100 compresses the data to be recorded to effectively record the information concerning the traveling state.

The receiving unit 101 receives an execution instruction for the execution of other processing excluding that for recording the information concerning the traveling state. For example, the receiving unit 101 receives commands to execute processing, such as music playback processing, image edit processing, and image playback processing. The receiving unit 101, for example, may receive the execution commands from a passenger of the mobile object or another device connected to the information recording apparatus 100.

The setting unit 102 sets, upon the receiving unit 101 receiving the execution instruction for the other processing while the recording processing is in progress, the compressibility of the information concerning the traveling state to be lower than that before the execution instruction for the other function. Additionally, when the other processing has been completed, the setting unit 102 sets the compressibility of the information concerning the traveling state to be higher than that during the execution of the other processing.

Compressibility is the ratio between the volume of data before and after compression. The volume of data after compression at a low compressibility is greater than the volume after compression at a high compressibility. In contrast, in general, the required amount of resources can be reduced in the case of compression at a low compressibility compared to compression at a high compressibility.

The control unit 103 controls the recording processing to be executed at the compressibility set by the setting unit 102.

The calculating unit 104 calculates the total amount of resources required to execute the recording processing and other processing when the receiving unit 101 receives the execution instruction for the other processing while the recording processing is in progress. For example, the total amount of resources is a sum of the amount of hardware resources (hereinafter, “resource amount” simply) used for the recording processing and the resource amount used for the other processing. When the total resource amount is calculated by the calculating unit, the setting unit 102, based on the calculated total resource amount, sets the compressibility of the information concerning the traveling state to be lower than that before the execution instruction for the other processing.

The judging unit 105 judges whether the total resource amount calculated by the calculating unit 104 is greater than a predetermined amount. For example, the predetermined amount is an upper limit of a resource amount of each device used for the recording processing.

The information recording apparatus 100 may record the information concerning the traveling state using a codec selected from among plural codecs each having a different hardware resource utilization amount (hereinafter, “resource amount”). The codec is an algorithm such as a calculation used for encoding/decoding data, and there are many kinds of codecs according to the type and purpose of the data to be encoded/decoded. Generally, the resource amount required for processing varies according to codec.

In this case, when the receiving unit 101 receives the execution instruction for the other processing while the recording processing is in progress, the calculating unit 104 calculates the total resource amount, which is a sum of the resource amount for the codec currently used for the recording processing and the resource amount required for executing the other processing. The setting unit 102 sets, based on the total resource amount calculated by the calculating unit 104, a codec to be used while the other processing is in progress. Then, the control unit 103 executes the recording processing using the codec set by the setting unit 102.

The judging unit 105 judges whether the total resource amount calculated by the calculating unit 104 is greater than a predetermined amount and based on a judgment result by the judging unit 105, the setting unit 102 may set a codec to be used while the other processing is in progress.

In this case, when the judging unit 105 judges that the total resource amount is greater than the predetermined amount, the calculating unit 104 calculates a new total resource amount that is a sum of the resource amount of a codec different from the currently used codec and the resource amount required to execute the other processing. Then, the judging unit 105 may judge whether the new total resource amount calculated by the calculating unit 104 is greater than the predetermined amount.

When the setting unit 102 sets no codec, the control unit 103 may stop execution of the recording processing or the other processing. A case in which no codec is set is a case in which the recording processing and the other processing cannot be executed simultaneously using any codec.

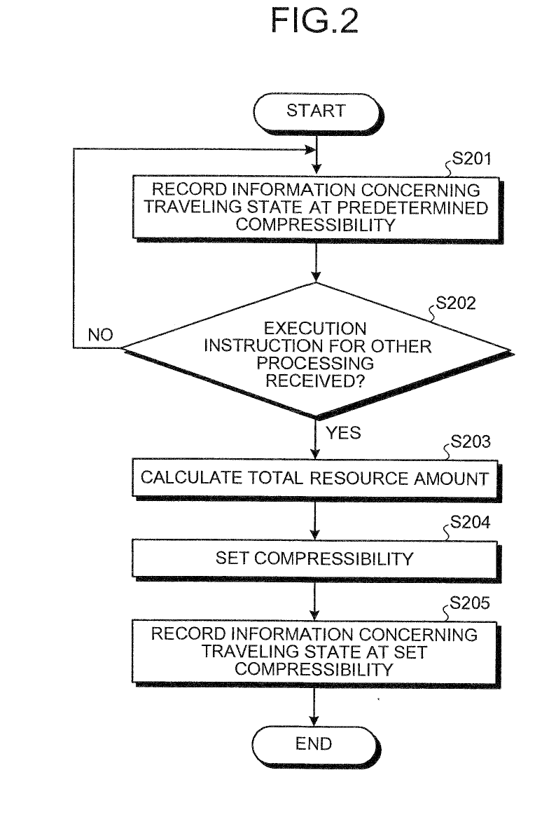

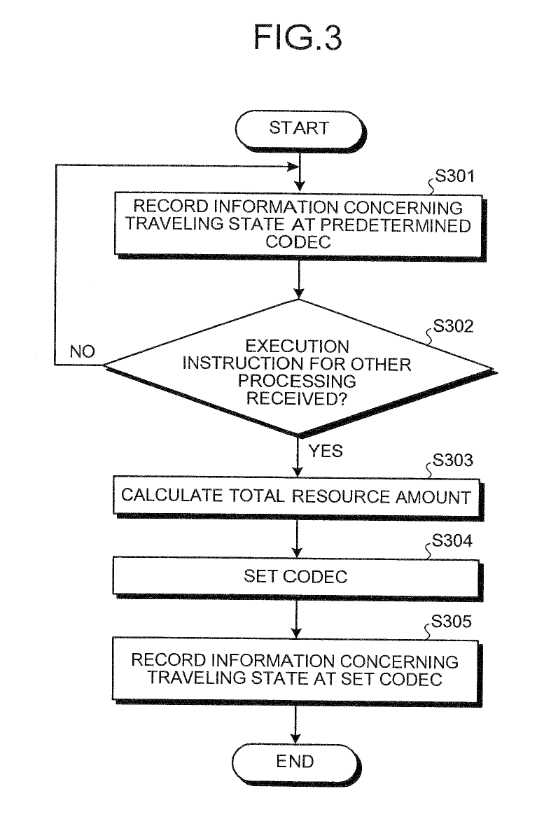

Information recording processing executed by the information recording apparatus 100 is explained. When receiving the execution instruction for the other processing excluding the recording processing, the information recording apparatus 100 changes the compressibility of the information to be recorded or the codec used for the recording processing. Processes for changing the compressibility of the information to be recorded and for changing the codec used for the recording processing are explained with reference to FIGS. 2 and 3, respectively.

FIG. 2 is a flowchart of a recording process for changing the compressibility of the information to be recorded. As shown in the flowchart of FIG. 2, the information recording apparatus 100 is recording information concerning a traveling state at a predetermined compressibility (hereinafter, “current compressibility”) (step S201). It is judged whether the receiving unit 101 has received an execution instruction for other processing excluding the recording processing (step S202). If the receiving unit 102 has not received an execution instruction for other processing (step S202: NO), the process returns to step S201, and the information concerning the traveling state continues to be recorded at the current compressibility.

If the receiving unit 101 has received an execution instruction for other processing (step S202: YES), the calculating unit 104 calculates a total resource amount required for executing the recording processing at the current compressibility and for executing the other processing (step S203). The setting unit 102 sets, based on the total resource amount calculated at step S203, a compressibility of the information to be recorded (step S204). The compressibility set at step S204 is lower than that before the execution instruction for the other processing, i.e., step S201.

The control unit 103 controls the compressibility and records the information concerning the traveling state at the compressibility set at step S204 (step S205), the processing ends. To record the information concerning the traveling state when the other processing has been completed, the compressibility may be reset to that before the execution instruction for the other processing.

A process for changing a codec used for the recording processing is explained. FIG. 3 is a flowchart of the recording process when a codec used for the recording processing is changed. As shown in the flowchart of FIG. 3, the information recording apparatus 100 is recording the information concerning the traveling state using a predetermined codec (hereinafter, “current codec”) (step S301).

It is judged whether the receiving unit 101 has received an execution instruction for other processing excluding the recording processing (step S302). If the receiving unit 101 has not received an execution instruction for other processing (step S302: NO), the process returns to step S301 and the information concerning the traveling state continues to be recorded using the current codec.

If the receiving unit 101 has received an execution instruction for other processing (step S302: YES), the calculating unit 104 calculates a total resource amount required for executing the recording processing using the current codec and for executing the other processing (step S303). The setting unit 102 sets a codec to be used for recording information based on the total resource amount calculated at step S303 (step S304). The setting unit 102 sets the codec to be used for recording information such that the total resource amount does not exceed an upper resource limit of the information recording apparatus 100 when the recording processing and the other processing are simultaneously executed. In some cases, the codec set at step S304 is identical to that before the execution instruction for the other processing.

The control unit 103 controls the compressibility, and records the information concerning the traveling state using the codec set at step S304 (step S305), the processing ends. To record the information concerning the traveling state when the other processing is complete, the codec may be reset to that before the execution instruction for the other processing.

When no codec is set at step S304, the control unit 105 may stop the recording processing or the other processing. For example, it may be judged which processing is to be stopped based on a current position, a velocity, a behavior of a passenger of the mobile object, etc.

As explained above, according to the information recording apparatus 100 of embodiment 1, upon receiving an execution instruction for other processing while the information concerning the traveling state is being recorded, the compressibility of the information concerning the traveling state or the codec used for the recording is changed. As a result, the other processing can be executed by appropriately using the limited resources of the information recording apparatus 100 without stopping the recording processing of the information concerning the traveling state.

When the compressibility or the codec is changed, the compressibility or the codec is set based on the total resource amount required for the recording processing and the other processing. As a result, when the compressibility or the codec need not be changed, for example, when the resource amount required for executing the other processing is small, the other processing can be executed without changing the compressibility or the codec.

When the other processing is complete, the compressibility or the codec is reset to that before the execution instruction for the other processing, constantly maintaining the quality of the information concerning the traveling state. When the recording processing and the other processing cannot be simultaneously executed at any compressibility or using any codec, any of the processing is stopped. As a result, each processing can be effectively executed using the limited resources of the information recording apparatus 100.

### Example 1

Examples of the information recording apparatus 100 according to embodiment 1 explained above are explained. A case in which the information recording apparatus 100 is applied to a navigation apparatus 400 provided in a vehicle is explained in examples 1 and 2 below.

### (Configuration of Peripheral Devices of Navigation Apparatus 400)

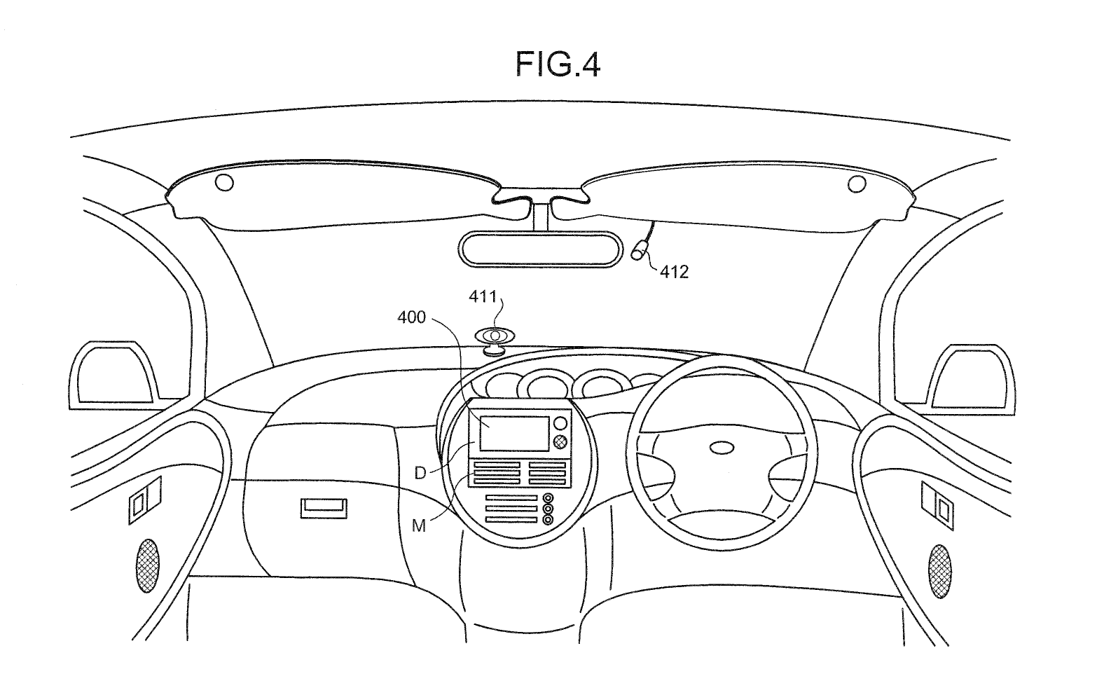

Peripheral devices of the navigation apparatus 400 are explained. FIG. 4 is an explanatory diagram of a vicinity of the dashboard of a vehicle in which the navigation apparatus is equipped. The navigation apparatus 400 is provided in the dashboard of the vehicle. The navigation apparatus 400 includes a main unit M and a display unit (display) D that displays a current position of the vehicle, map information, a current time, etc.

An onboard camera 411 provided on the dashboard and an onboard microphone 412 provided on a sun visor are connected to the navigation apparatus 400. The onboard camera 411 includes fixed cameras for shooting an external area in front of the vehicle and for shooting the interior of the vehicle. The onboard microphone 412 is used to operate the navigation apparatus 400 by audio input or to record sounds inside the vehicle. The onboard camera 411 is not limited to installation on the dashboard, and may be attached to the back of a rear-view mirror equipped in the vehicle, for example. In this case, only images outside the vehicle are shot.

Although not shown, the onboard camera 411 may be provided at the rear of the vehicle. When the onboard camera 411 is provided at the rear of the vehicle, safety at the rear of the vehicle can be confirmed, and circumstances upon being rear-ended by another vehicle can be recorded. The onboard camera 411 may be an infrared camera for recording in dark places. Plural onboard cameras 411 and onboard microphones 412 may be equipped in the vehicle, and these cameras may be movable, not fixed.

The navigation apparatus 400 has a drive recording function of recording the traveling state of the vehicle in addition to route retrieval for a destination and information recording. The drive recording function is a function of recording, on a recording medium of the navigation apparatus 400 (a magnetic disk 505, an optical disc 507 explained hereinafter), images and sounds obtained by the onboard camera 411 and the onboard microphone 412, current position information, change in the velocity of the vehicle obtained by a GPS unit 515 and various sensors 516, etc. explained hereinafter.

By a continuous recording of the traveling state using the drive recording function, in the event the vehicle is involved in an accident or an accident occurs near the vehicle, documentation that can be used in an investigation related to the accident can be obtained. The information to be recorded using the drive recording function may be stored as long as the information does not exceed the memory capacity of the recording medium, or may be sequentially deleted retaining a predetermined interval.

The navigation apparatus 400 has various functions such as playback of a DVD or a CD, receiving/recording of a TV broadcast, connection to the Internet. Similar to the drive recording function, these functions are executed using a hardware resource of the navigation apparatus 400 (hereinafter, “resource” simply). Therefore, when trying to execute another function while executing the drive recording function, the resources might become insufficient, and the drive recording function must be stopped in such a case. On the other hand, since the drive recording function is for recording an accident that can occur at any time, it is preferable to continue the drive recording operation.

In such a case, the navigation apparatus 400 adjusts the compressibility of the drive recording function, and utilization of the resources for the drive recording function. As a result, the drive recording operation can be continued as long as possible, and the other function of the navigation apparatus 400 can be simultaneously executed.

### (Hardware Configuration of Navigation Apparatus 400)

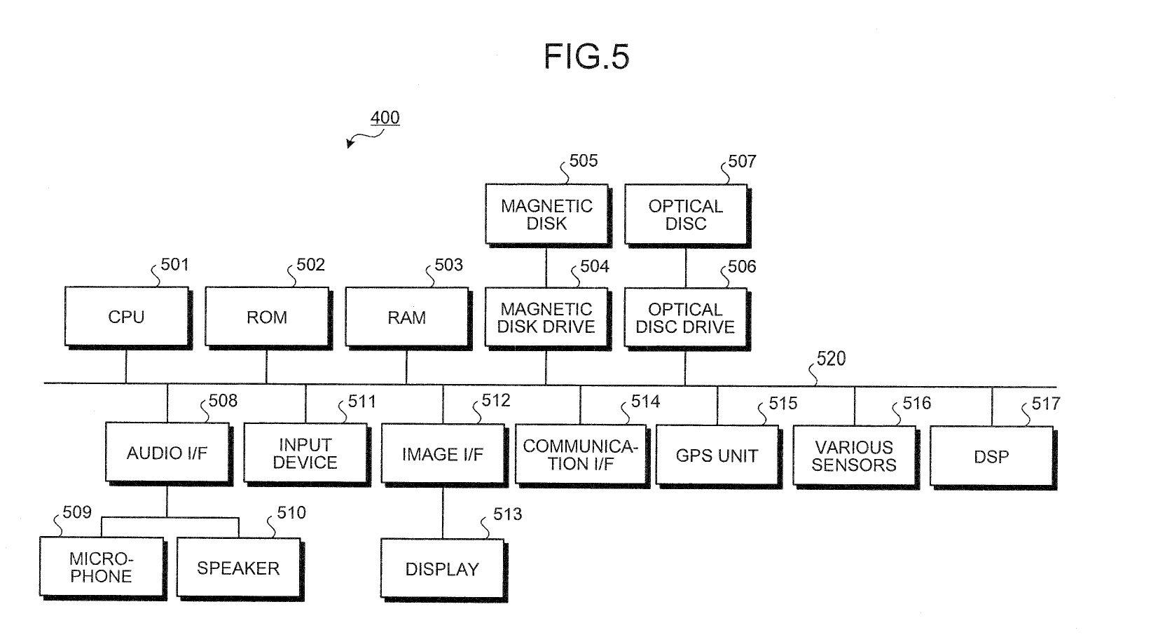

A hardware configuration of the navigation apparatus 400 is explained. FIG. 5 is a block diagram of the hardware configuration of the navigation apparatus. As shown in FIG. 5, the navigation apparatus 400 includes a CPU 501, a ROM 502, a RAM 503, a magnetic disk drive 504, a magnetic disk 505, an optical disc drive 506, an optical disc 507, an audio interface (I/F) 508, a microphone 509, a speaker 510, an input device 511, an image I/F 512, a display 513, a communication I/F 514, a GPS unit 515, various sensors 516, and a DSP 517. The components 501 to 517 are connected via a bus 520.

The CPU 501 controls the navigation apparatus 400 overall. The ROM 502 stores a program such as a boot program, a communication program, a database generation program, and a data analysis program. The RAM 503 is used as a work area of the CPU 501.

The magnetic disk drive 504 controls writing/reading of data to/from the magnetic disk 505 under the control of the CPU 501. The magnetic disk 505 stores data that is written therein under the control of the magnetic disk drive 504. The magnetic disk 505 includes, for example, an HD (hard disk) and an FD (flexible disk).

The optical disc drive 506 controls writing/reading of data to/from the optical disc 507 under the control of the CPU 501. The optical disc 507 is a removable recording medium from which data is read under the control of the optical disc drive 506. A writable recording medium can be used as the optical disc 507. In addition to the optical disc 507, an MO or a memory card can be used as the removable recording medium.

The information recorded in the magnetic disk 505 and the optical disc 507 includes images and sounds inside and outside the vehicle obtained by the onboard camera 411 and the onboard microphone 412 shown in FIG. 4, current position information of the vehicle detected by the GPS unit 515 explained hereinafter, an output value from the various sensors 516, etc. The above information is recorded by the drive recording function of the navigation apparatus 400, and used as verification documentation at the time of a traffic accident.

Other information recorded in the magnetic disk 505 and the optical disc 507 includes map information used for route retrieval/route guidance. The map information includes background data representing features such as buildings, rivers, and ground surfaces, and road shape data representing a shape of a road, and is displayed on a screen of the display 513 two dimensionally or three dimensionally When the navigation apparatus 400 is executing the route guidance, the map information and the current position of the vehicle obtained by the GPS unit explained hereinafter are superimposed and displayed.

The road shape data includes traffic condition data. The traffic condition data includes information concerning the presence of a traffic light, a crosswalk, an entrance and an exit of an expressway for each node, a length (distance) of each link, a width of a road, a traveling direction, a kind of a road (expressway, toll road, general road, etc.).

The traffic condition data includes past congestion information that is information concerning past congestion statistically processed according to a season, a day of the week, a long vacation, and time, etc. The navigation apparatus 400 obtains information concerning current congestion based on the road traffic information received by the communication I/F 514 explained hereinafter, and can estimate congestion condition at a designated time based on the past congestion information.

Although the map information is stored in the magnetic disk 505 and the optical disc 507 in the present example, it is not limited hereto. The map information is not limited to be stored in what is provided with the hardware of the navigation apparatus 400, and may be provided externally from the navigation apparatus 400. In this case, the navigation apparatus 400 obtains the map information through the communication I/F 514 via the network, for example. The obtained map information is stored in the RAM 503, etc.

The audio I/F 508 is connected to the microphone 509 for audio input (such as the onboard microphone 412 in FIG. 4), and the speaker 510 for audio output. The audio received by the microphone 509 is analog-to-digital (A/D) converted at the audio I/F 508. The speaker 510 outputs audio. The audio input through the microphone 509 can be recorded in the magnetic disk 505 or the optical disc 507 as audio data.

The input device 511 includes a remote controller including plural keys to input characters, numbers, various instructions, etc., a keyboard, a mouse, and a touch panel. The input device 511 can be connected to another information processing terminal (hereinafter, “device” simply) such as a digital camera or a cellular phone terminal, and execute the input/output of data.

The image I/F 512 is connected to the display 513. The image I/F 512 includes, for example, a graphic controller that controls the display 513 overall, a buffer memory such as a VRAM (video RAM) that temporarily stores immediately-displayable image data, a control integrated circuit (IC) that controls the display 513 based on image data output from the graphic controller. The onboard camera 411 in FIG. 4 is connected to the image I/F 512, and images inside/outside of the vehicle are input thereto.

The display 513 displays an icon, a cursor, a menu, a window, various data such as characters and images. For example, a CRT, a TFT liquid crystal display, a plasma display etc. are used as the display 413. The display 513 is set in a manner as the display unit D in FIG. 4, for example.

The communication I/F 514 is connected to a network via radio transmission, and works as an interface between the navigation apparatus 400 and the CPU 501. The communication I/F 514 is connected to a communication network such as the Internet via radio transmission, and works as an interface between the network and the CPU 501.

The network includes a LAN, a WAN, a public line network, a cellular phone network, etc. More specifically, the communication I/F 514 includes, for example, an FM tuner, a VICS (vehicle information and communication system)/beacon receiver, a wireless communication device, and other communication devices, and obtains, from the VICS center, traffic information such as traffic congestion and traffic regulations. The VICS is a registered trademark.

The GPS unit 515 calculates information indicating a current position of the vehicle (current position of the navigation apparatus 400) using signals received from GPS satellites and values output from the various sensors 516. For example, the information indicating the current position is information identifying a point on the map information such as latitude, longitude, and altitude. The GPS unit 515 outputs an odometer, velocity variation, orientation variation using output values from the various sensors 516. As a result, dynamics such as sudden braking and sudden maneuvering can be analyzed.

The various sensors 516 include a velocity sensor, an acceleration sensor, an angular velocity sensor, and values output therefrom are used for the calculation of a current position by the GPS unit 515 or for measuring variations in velocity or orientation. The values output from the various sensors 516 may be data to be recorded by the drive recording function.

The DSP (digital signal processor) 517 is a microprocessor specialized for processing audio and images, and processes images shot by the onboard camera 411 and audio recorded by the onboard microphone 412. For example, the DSP 517 executes processing for changing a resolution by thinning out pixel data of the captured images, processing to cut a part of the captured images, encoding processing using plural compression codecs having different required resource amounts, and encoding processing using an image compression codec for which compressibility is changeable.

In the functional configuration of the information recording apparatus 100 according to embodiment 1, the function of the receiving unit 101 is implemented by the input device 511, and the functions of the setting unit 102, the control unit 103, the calculating unit 104, and the judging unit 105 are implemented by the CPU 501.

### (Compressibility Switch Processing Executed by Navigation Apparatus 400)

Compressibility switch processing executed by the navigation apparatus 400 is explained. As explained above, the resources may be insufficient for the navigation apparatus 400 to simultaneously execute the drive recording function and another function. In this case, the navigation apparatus 400 changes a compressibility (resolution) of the images to be recorded to reduce the resources required for the drive recording function. As a result, the resource insufficiency can be covered, and the other function can be executed without stopping the drive recording function.

In the drive recording function, the DSP 517 resources required for recording the images captured by the onboard camera 411 differs according to the resolution and the shooting range of images to be recorded, screen size (i.e., the amount of source image data), type and compressibility of an image compressing codec. For example, if the images captured by the onboard camera 411 are recorded at a resolution reduced to a degree that the subject can be identified (in terms of the drive recording function, the image is usable as evidence), the amount of data to be recorded decreases, and a required amount of memory can be reduced.

On the other hand, compression processing for thinning out the image data is executed to reduce the resolution. Generally, when the thinning amount (compressibility) increases, the resources required for the thinning processing (compression) increases. Particularly, the rate of increase becomes significant when a function of complementing the thinned data is provided.

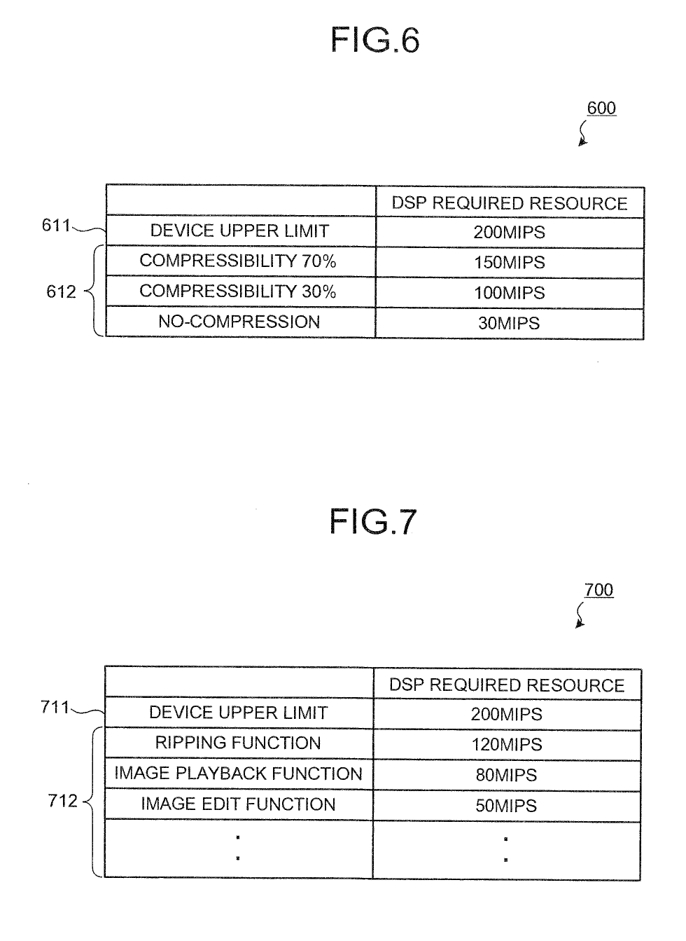

FIG. 6 is a schematic of an example of required resources according to compressibility. A table of required resources for each compressibility (hereinafter, compressibility-resource table) 600 includes a device upper limit 611 indicating the maximum resource amount of the DSP and a required resource for each compressibility 612. In the example shown, the device upper limit 611 of the DSP 517 is 200 MIPS. The MIPS (million instructions per second) is a unit of processing speed of a computer (mainly, microcomputer performance), and 1 MIPS indicates that the computer can process a command 1 million times in 1 second.

The percentage of the compressibility indicates the amount of data after compression, where the amount of data before compression is 100%. For example, data after compression is 30 MB when data of 100 MB is compressed at a compressibility of 70%, and 70 MB when the data is compressed at a compressibility of 30%. Therefore, the higher the percentage of the compressibility is, the higher the compressibility is.

The required resources for each compressibility 612 are 150 MIPS when the compressibility is 70%, 100 MIPS when the compressibility is 30%, and 30 MIPS when compression is not executed. The lower the compressibility is, the fewer the required resources are. The DSP 517 can switch between 70% compressibility, 30% compressibility, and no-compression to process image data. When the drive recording function is in operation, the compression processing is executed normally at the compressibility of 70%.

FIG. 7 is a chart of examples of required resources according to function. A table of required resources for each function (hereinafter, “function-resource table”) 700 includes a device upper limit 711 indicating the maximum resource amount of the DSP, and required resources for each function 712. In the example shown, similar to FIG. 6, the device upper limit 711 of the DSP 517 is 200 MIPS. The required resources for each function 712 is 120 MIPS for a ripping function as an example of the function, 80 MIPS for an image playback function, and 50 MIPS for an image edit function.

The navigation apparatus 400 stores the compressibility-resource table 600 and the function-resource table 700, and switches the compressibility of image data to save the resources required for other processing when an execution instruction for another function is received while the drive recording function is in progress. Hereinafter, compressibility switch processing executed by the navigation apparatus 400 is explained.

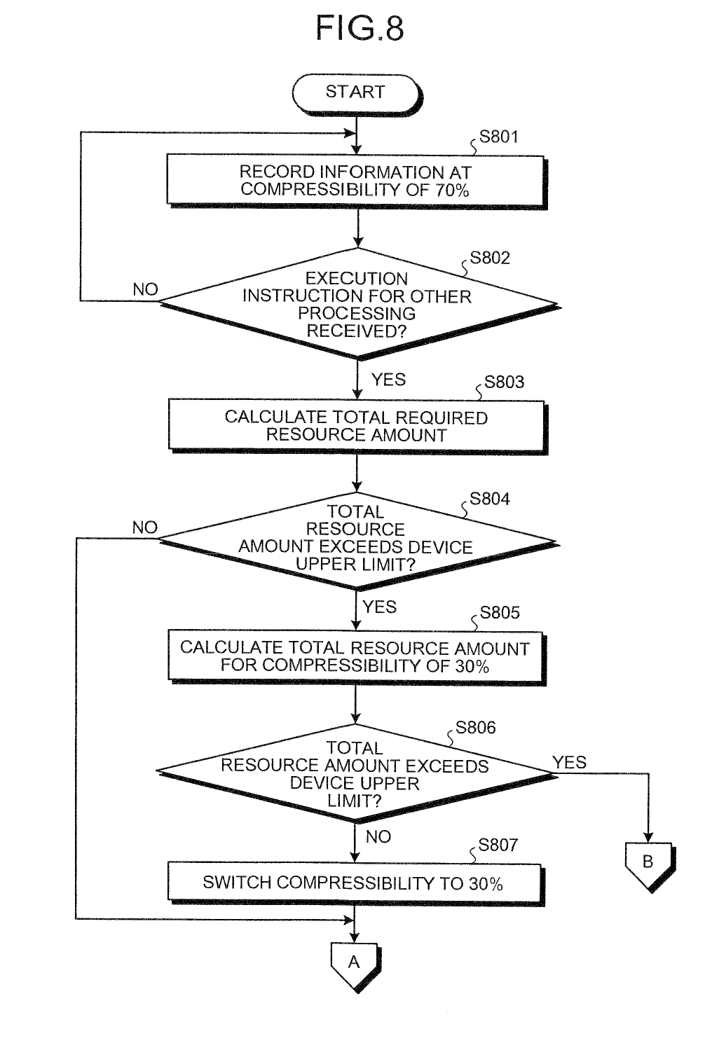

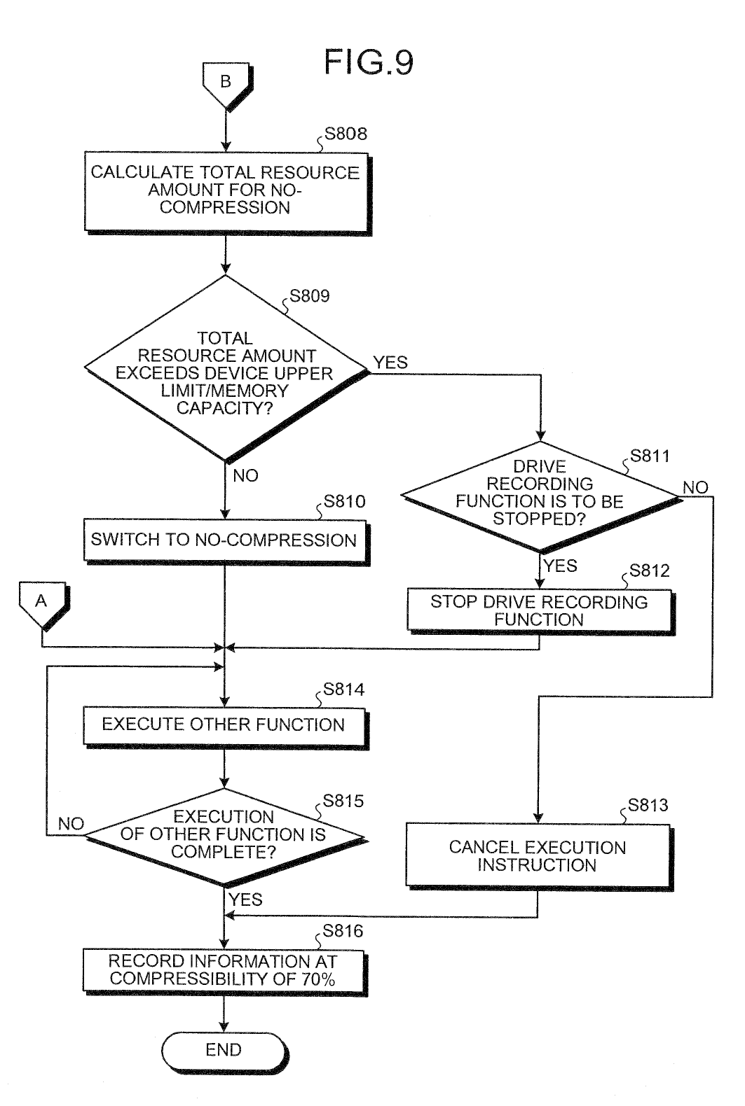

FIGS. 8 and 9 are flowcharts of a compressibility switch process executed by the navigation apparatus. As shown in the flowchart of FIG. 8, the navigation apparatus 400 is processing and recording the image data captured by the onboard camera 411 at a compressibility of 70% through the DSP 517 (step S801). It is judged through the input device 511 whether an execution instruction for another function has been received (step S802). An execution instruction for another function may be initiated by a passenger of the vehicle, or automatically initiated according to the traveling state of the vehicle.

When an execution instruction for another function has not been received (step S802: NO), the process returns to step S801, and recording at the compressibility of 70% continues. On the contrary, when an execution instruction for another function is received (step S802: YES), a total resource amount required for simultaneously executing the drive recording function and the other processing is calculated (step S803). Specifically, for example, when an execution instruction for the image playback function as the other function is received, the resource amount of 80 MIPS required for the image playback function (see FIG. 7) and the resource amount of 150 MIPS required for the recording at the compressibility of 70% (see FIG. 6) are added. As a result, the total resource amount is 230 MIPS.

It is judged whether the calculated total resource amount exceeds the device upper limit (step S804). For example, in the example shown in FIG. 6, the device upper limit 611 is 200 MIPS, and the total resource amount of 230 MIPS, for simultaneous execution of the drive recording function and the image playback function, exceeds the device upper limit.

When the total resource amount does not exceed the device upper limit (step S804: NO), the process proceeds to step S814 in FIG. 9. On the contrary, when the total resource amount exceeds the device upper limit (step S804: YES), a total resource amount is calculated for a compressibility of 30% (step S805). In this case, a resource amount of 100 MIPS required for recording at the compressibility of 30% (see FIG. 6) and the resource amount of 80 MIPS required for the image playback function are added, and the total resource amount is 180 MIPS.

It is judged whether the calculated total resource amount exceeds the device upper limit (step S806). For example, in the above case, the calculated total resource amount of 180 MIPS does not exceed the device upper limit. When the calculated total resource amount does not exceed the device upper limit (step S806: NO), the compressibility of image data is switched to 30% (step S807), and the process proceeds to step S814 in FIG. 9. On the contrary, when the calculated total resource amount exceeds the device upper limit (step S806: YES), the process proceeds to step S808 in FIG. 9.

As shown in FIG. 9, when the calculated total resource amount exceeds the device upper limit (step S806: YES), a total resource amount for no-compression is calculated (step S808). In this case, the resource amount of 30 MIPS required for recording without compression (see FIG. 6) and the resource amount required for the other processing instructed at step S802 are added.

It is judged whether the calculated total resource amount exceeds the device upper limit (step S809). When the calculated total resource amount does not exceed the device upper limit (step S809: NO), the compressibility of the image data is switched to no-compression (step S810), and the process proceeds to step S814. On the contrary, when the calculated total resource amount exceeds the device upper limit (step S809: YES), it is judged whether the drive recording function is to be stopped (step S811). For example, this judgment is executed by causing the display 513 to display a confirmation message and causing a user to make a selection.

When the drive recording function is to be stopped (step S811: YES), the drive recording function is stopped (step S812), and the process proceeds to step S814. As a result, the resource amount required for the drive recording function becomes zero, and sufficient resources become available for the execution of the other processing. In contrast, when the drive recording function is not to be stopped (step S811: NO), the execution instruction for the other function is cancelled (step S813), and the process proceeds to step S816.

When the compressibility is switched to 30% at step S807 or to no-compression at step S810, or when the drive recording function is stopped at step S812, the other processing instructed at step S802 is executed (step S814). The DSP 517 continues to record image data even while executing the other processing except when the drive recording function is stopped at step S812. Until the other processing is complete (step S815: NO), the process returns to step S814, and the other processing continues to be executed.

When the other processing is complete (step S815: YES), image data is recorded at the compressibility of 70% (step S816), the processing ends. At this time, when the drive recording function is stopped at step S812, execution of the drive recording function is restarted, and recording is executed at a compressibility of 70%. When the compressibility has been switched at steps S807 or S810, the compressibility is switched to the original compressibility of 70%, and recording is executed. When the total resource amount does not exceed the device upper limit at step S804, or when the other processing is cancelled at step S813, since recording is being continued at the compressibility of 70%, the recording processing continues as is.

Although a case in which the compressibility is changed is explained above, a shooting range of the onboard camera 411 or screen size may be adjusted. When the execution instruction for the other function is for plural functions, a total resource amount required for executing each function and recording at each compressibility are calculated at steps S803, S805, and S808.

As explained above, according to the navigation apparatus 400 of example 1, upon receiving an execution instruction for another function while executing the drive recording function, the compressibility of the drive recording function is lowered. As a result, the other processing can be executed without stopping the drive recording function by appropriately using the limited resources of the navigation apparatus 400.

### Example 2

The navigation apparatus 400 according to example 1 secures resources required for executing other processing by changing the compressibility of image data to be recorded. The navigation apparatus 400 according to example 2 secures resources required for the execution other processing by changing the codec used for recording images. In the explanation below, since a configuration of peripheral devices (see FIG. 4) and a hardware configuration (see FIG. 5) of the navigation apparatus 400 are identical to those in example 1, detailed explanation thereof is omitted, and like reference characters are used.

Hardware (device) required for the drive recording function varies according to the type of image recording method (an image compression codec, hereinafter, “codec”). For example, the type of device used for the drive recording function, the memory amount consumed for recording per unit of time, etc. are different. Each codec has a unique consumption for each device resource. For example, a high compression codec consumes a large amount of resources of DSP 517, but causes a little memory load (such as on the RAM 503). In contrast, a non-compressive codec consumes a small amount of resources of the DSP 517, but causes much load on the memory (such as the RAM 503).

Upon executing another function, the navigation apparatus 400 according to example 2 changes the codec used for recording image data with consideration of a utilization condition of resources of each device. In this case, the DSP 517 includes required hardware retaining different compression codec encoders.

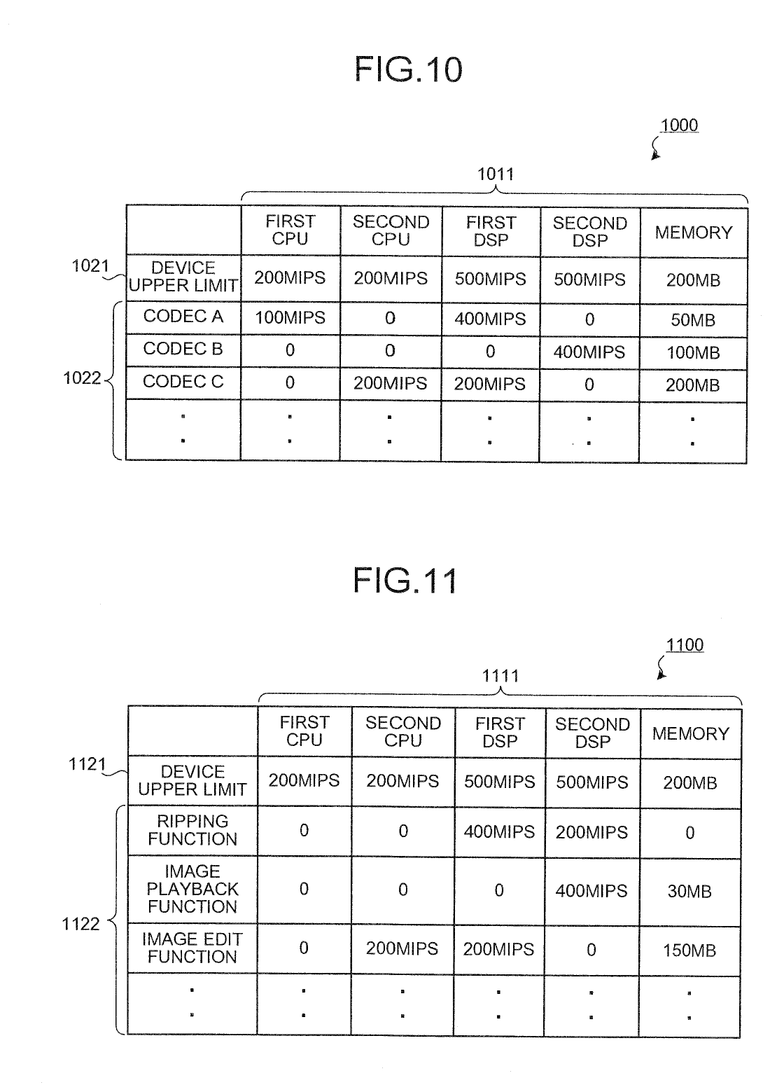

FIG. 10 is a chart of examples of required resources according to codec. A table of required resources for each codec (hereinafter, “codec-resource table”) 1000 includes a device 1011 required for processing using each codec, a device upper limit 1021 indicating the maximum resource amount of each device, a required resource for each codec 1022 that is a resource amount required for the processing using each codec. In the example shown, a first CPU, a second CPU, a first DSP, a second DSP, and memory are shown as the device 1011 required for the processing using each codec.

As for the device upper limit 1021 indicating the maximum resource amount of each device, the device upper limits of the first and the second CPUs are each 200 MIPS, the device upper limits of the first and the second DSPs are each 500 MIPS, and the device upper limit of the memory is 200 MB. As for the required resource for each codec 1022, for example, in the case of processing using a codec A, the first CPU requires 100 MIPS, the first DSP requires 400 MIPS, and the memory requires 50 MB. The required resource for each codec is applicable for the required resource for each compressibility.

FIG. 11 is a chart of examples of required resources according to function. A table of required resources for each function (hereinafter, “function-resource table”) 1100 includes a device 1111 required for executing each function, a device upper limit indicating the maximum resource amount of each device, and a required resource for each function 1122. In the example shown, for example, in the case of executing an image edit function, the second CPU requires 200 MIPS, the first DSP requires 200 MIPS, and the memory requires 150 MB.

The navigation apparatus 400 stores the codec-resource table 1000 and the function-resource table 1100, and switches a codec of image data to secure resources required for other processing upon receiving an execution instruction for the other function while executing the drive recording function. Hereinafter, codec switch processing executed by the navigation apparatus 400 is explained.

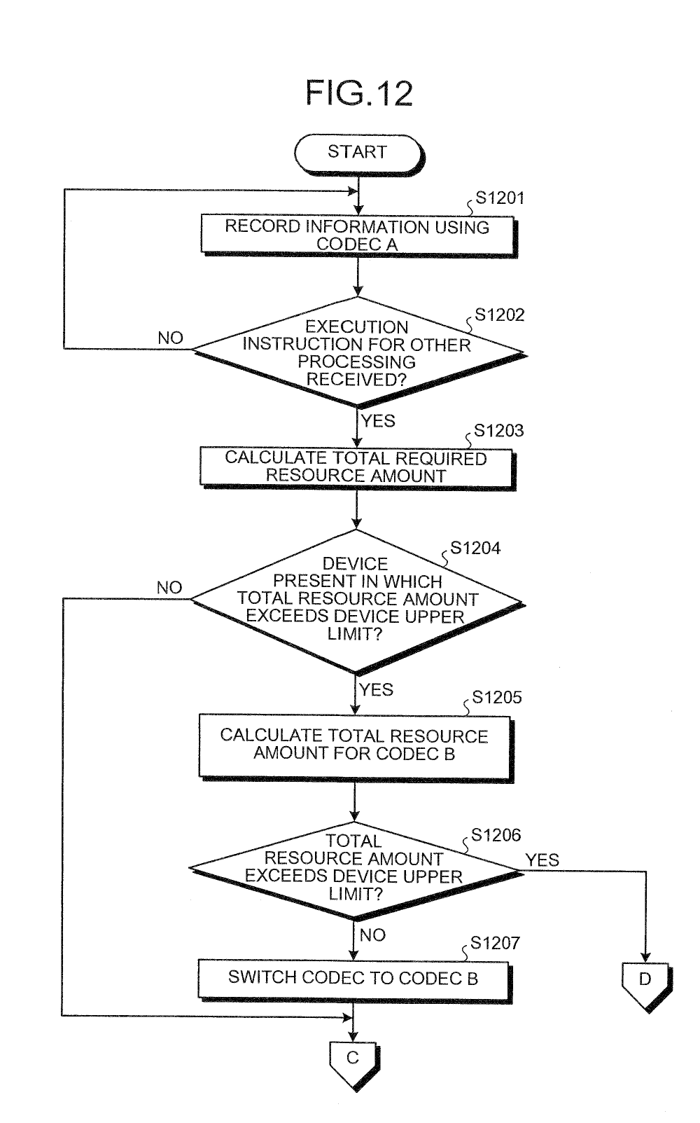

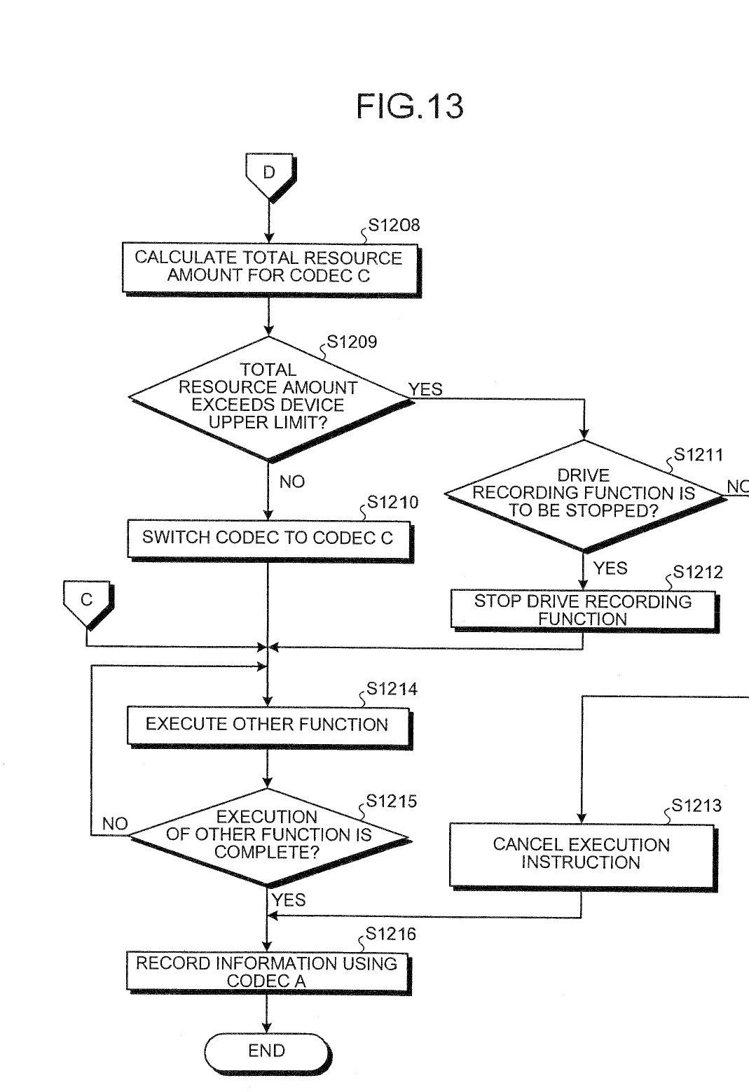

FIGS. 12 and 13 are flowcharts of the codec switch processes executed by the navigation apparatus. As shown in the flowchart of FIG. 12, the navigation apparatus 400 is recording the image data captured by the onboard camera 411 using the codec A (step S1201). It is judged through the input device 511 whether an execution instruction for another function has been received (step S1202). An execution instruction for another function may be initiated by a passenger of the vehicle, or automatically initiated according to the traveling state of the vehicle.

When an execution instruction for another function is not received (step S1202: NO), the process returns to step S1201, and recording using the codec A continues. On the contrary, when an execution instruction for another function is received (step S1202: YES), a total resource amount for each device required for simultaneous execution of the drive recording function and the other processing is calculated (step S1203).

Specifically, for example, when the execution instruction for the image edit function as the other processing is received, 200 MIPS of the second CPU, 200 MIPS of the first DSP, and 150 MB of the memory that are the resources required for executing the image edit function (see FIG. 11), and 100 MIPS of the first CPU, 400 MIPS of the first DSP, 50 MB of the memory that are the resources required for the recording using the codec A (see FIG. 10) are added.

It is judged whether the calculated total resource amount exceeds the device upper limit (step S1204). For example, in the case of the image edit function and the codec A above, the required resource of the first DSP is 600 MIPS, which exceeds the device upper limit.

When the total resource amount does not exceed the device upper limit (step S1204: NO), the process proceeds to step S1214 in FIG. 13. On the contrary when the total resource amount exceeds the device upper limit (step S1204: YES), a total resource amount in the case of using the codec B is calculated (step S1205). In this case, the resource amount required for recording using the codec B (see FIG. 10) and the resource amount required for the image edit function are added.

It is judged whether the calculated total resource amount exceeds the device upper limit (step S1206). For example, in the case of the image edit function and the codec B above, the calculated total resource amount for any device does not exceed the device upper limit. When the calculated total resource amount does not exceed the device upper limit (step S1206: NO), the codec used for the image data is switched to the codec B (step S1207), and the process proceeds to step S1214 in FIG. 13. On the contrary, when the calculated total resource amount exceeds the device upper limit (step S1206: YES), the process proceeds to step S1208 in FIG. 13.

As shown in FIG. 13, when the calculated total resource amount exceeds the device upper limit (step S1206: YES), a total resource amount in the case of using the codec C is calculated (step S1208). In this case, the resource amount required for the recording using the codec C (see FIG. 10) and the resource amount required for the function instructed at step S1202 are added.

It is judged whether the calculated total resource amount exceeds the device upper limit (step S1209). When the calculated total resource amount does not exceed the device upper limit (step S1209: NO), the codec used for the image data is switched to the codec C (step S1210), the process proceeds to step S1214.

On the contrary, when the calculated total resource amount exceeds the device upper limit (step S1209: YES), it is judged whether the drive recording function is to be stopped (step S1211). For example, this judgment is executed by causing the display 513 to display a confirmation message and causing a user to make a selection.

When the drive recording function is to be stopped (step S1211: YES), the drive recording function is stopped (step S1212), the process proceeds to step S1214. As a result, a resource amount required for the drive recording function becomes zero, resources for executing the other function do not become insufficient. Priorities of the drive recording function and the other function may preliminarily set to decide which function is to be stopped based on the priorities. In this case, the priorities may be arbitrarily set by a user or by the navigation apparatus 400 according to the traveling state such as whether a current position of the vehicle is at a point such as an intersection where an accident is likely to occur, whether a continuous driving period of time is greater than a predetermined period of time, or whether a velocity is greater than a predetermined velocity.

When the drive recording function is not to be stopped (step S1211: NO), the execution instruction for the other function is cancelled (step S1213), and the process proceeds to step S1216.

When the codec is switched at step S1207 or S1210, or when the drive recording function is stopped at step S1212, the other function instructed at step S1202 is executed (step S1214).

The DSP 517 continues to record image data except when the drive recording function is stopped at step S1212. Until the other function is complete (step S1215: NO), the process returns to step S1214, and the other function continues to be executed.

When the other function is complete (step S1215: YES), image data is recorded using the codec A as before receiving the execution instruction for the other function (step S1216), the processing ends. At this time, when the drive recording function is stopped at step S1212, execution of the drive recording function is restarted. When the codec is switched at steps S1207 or S1210, the codec is switched to the original codec A. When the total resource amount does not exceed the device upper limit at step S1204, or when the execution instruction for the other function is cancelled at step S1213, since the recording is being continued using the codec A, the recording processing continues as is.

When receiving another execution instruction for another function, or when receiving plural instructions for executing other functions, the required resources for each codec are summed for each device and compared with the device upper limits, and a codec for which the total required resource amount does not exceed the device upper limit is selected. When plural codecs met the condition, a codec used for the recording is set based on the priorities of codecs or devices that are preliminarily set.

As explained above, the navigation apparatus 400 according to examples 1 and 2, upon receiving an execution instruction for another function while executing the drive recording function, a compressibility of the drive recording function or a codec used for the recording is changed. As a result, the other function can be executed without stopping the drive recording function by appropriately using limited resources of the navigation apparatus 400.

When the compressibility or the codec is changed, the compressibility or the codec is set based on the total resource amount required for the recording processing and the other processing. As a result, when the compressibility or the codec need not be changed, for example, when the resource amount required for the other function is small, the other processing can be executed without changing the compressibility or the codec. When execution of the other function is complete, the compressibility or the codec is reset to that before the execution instruction for the other function, constantly maintaining the quality of data to be recorded.

When the recording processing and the other processing cannot be simultaneously executed at any compressibility or using any codec, either of the functions is stopped. As a result, each function can be effectively executed by using the limited resources of the navigation apparatus. When the resource required for executing both functions is insufficient, the functions are appropriately switched and executed by assigning a priority to each function.

### Embodiment 2

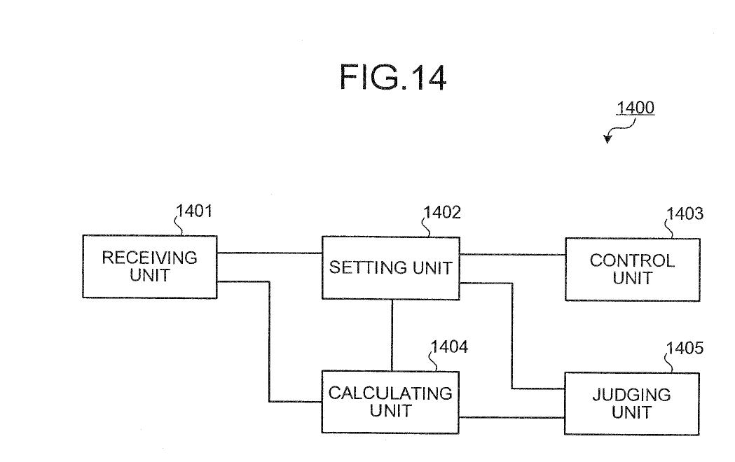

A functional configuration of an information recording apparatus 1400 according to embodiment 2 is explained. FIG. 14 is a block diagram of a functional configuration of an information recording apparatus according to embodiment 2. The information recording apparatus 1400 includes a receiving unit 1401, a setting unit 1402, a control unit 1403, a calculating unit 1404, and a judging unit 1405.

For example, the information recording apparatus 1400 is provided in a mobile object such as a vehicle, and records information concerning a traveling state of the mobile object. The information concerning the traveling state includes travel route information of the mobile object (such as a passage point and a passage time), velocity information, images and sounds of surroundings of where the mobile object travels. For example, the information recording apparatus 1400 may record the information concerning the traveling state continuously from a travel start time to a travel end time of the mobile object, only for a designated interval, or at a given interval.

The information recording apparatus 1400 can compress and record the information concerning the traveling state. The information concerning the traveling state includes images or sounds of a relatively large data volume, which increases when the information concerning the traveling state is recorded continuously. Therefore, the information recording apparatus 1400 compresses the data to be recorded to effectively record the information concerning the traveling state. However, compression causes deterioration of data quality. Therefore, in some cases, compression is not executed, or compressibility is set lower to maintain the data quality according to intended use.

The receiving unit 1401 receives an execution instruction for other processing excluding the processing of recording the information concerning the traveling state. For example, the receiving unit 1401 receives commands to execute processing, such as music playback processing, image edit processing, and image playback processing. The receiving unit 101, for example, may receive the instruction from a passenger of the mobile object or another device connected to the information recording apparatus 1400.

When the receiving unit 1401 receives an execution instruction for other processing while the recording processing is in progress, the setting unit 1402 sets a compressibility of the information concerning the traveling state lower than that before the execution instruction for the other processing. The compressibility is the ratio between the amount of data before a compression and the amount of data after the compression. The amount of data after the compression becomes less in the case of the compression at a high compressibility than in the case of the compression at a low compressibility. Therefore, the amount of data occupying a recording medium can be reduced in the case of the compression at a high compressibility.

The control unit 1403 executes the recording processing at the compressibility set by the setting unit 1402. Additionally, the control unit 1403 stops the recording processing and the other processing when the setting unit 1402 sets no compressibility.

When the receiving unit 1401 receives an execution instruction for other processing while the recording processing is in progress, the calculating unit 1404 calculates the total amount of data that would occupy the recording-medium in the event that the recording processing and the other processing are executed simultaneously. This total data amount is a sum of the amount of the information concerning the traveling state at the current compressibility and the amount of information to be obtained and generated by the other processing.

When the calculating unit 1404 calculates the total data amount, the setting unit 102 sets the compressibility of the information concerning the traveling state higher than that before the execution instruction for the other processing based on the total data amount calculated by the calculating unit 1404. For example, the setting unit 1402 sets the compressibility higher than that before the execution instruction for the other processing when the total data amount exceeds the capacity of the recording medium of the information recording apparatus 1400.

The judging unit 1405 judges whether the total data amount calculated by the calculating unit 1404 is greater than a predetermined amount. For example, the predetermined amount is the capacity of the recording medium of the information recording apparatus 1400. In this case, the judging unit 1405 judges whether the total data amount exceeds the capacity of the recording medium. When the judging unit 1405 executes the judgment, the setting unit 1402 sets the compressibility of the information concerning the traveling state higher than that before the execution instruction for the other processing based on a judgment result.

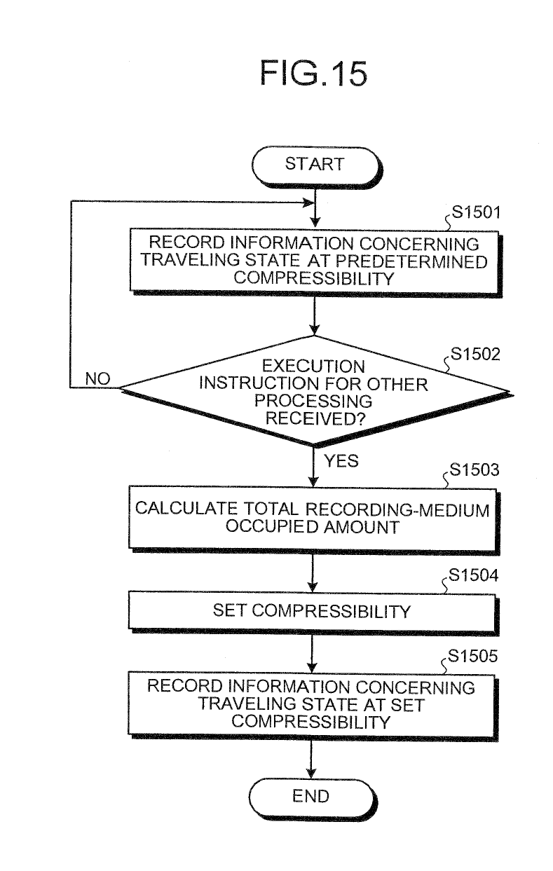

A process for changing a compressibility of the information concerning the traveling state is explained. FIG. 15 is a flowchart of the process for changing a compressibility of the information concerning the traveling state. As shown in the flowchart of FIG. 15, the information recording apparatus 1400 is recording information concerning a traveling state at a predetermined compressibility (hereinafter, “current compressibility”) (step S1501).

It is judged whether the receiving unit 1401 has received an execution instruction for other processing excluding the recording processing (step S1502). When the receiving unit 1401 has not received an execution instruction for other processing (step S1502: NO), the process returns to step S1501, and the information concerning the traveling state continues to be recorded at the current compressibility.

When the receiving unit 1401 receives as execution instruction for other processing (step S1502: YES), the calculating unit 1404 calculates a total recording-medium occupied amount for the execution of the recording processing at the current compressibility and the other processing (step S1503). The setting unit 1402 sets a compressibility of the information concerning the traveling state based on the total data amount calculated at step S1503 (step S1504). For example, the setting unit 1402 sets, as the compressibility of the information concerning the traveling state, a compressibility such that the total data amount when executing the recording processing and the other processing does not exceed the capacity of the recording medium of the information recording apparatus 1400. In some cases, the compressibility set at step S1504 is identical to that before the execution instruction for the other processing.

The control unit 1403 controls the compressibility, and records the information concerning the traveling state at the compressibility set at step S1504 (step S1505), and the processing ends. To record the information concerning the traveling state when the other processing is complete, the compressibility may be reset to that before the execution instruction for the other processing.

When no compressibility is set at step S1504, the control unit 1403 may stop the recording processing or the other processing. For example, it may be judged which processing is to be stopped based on a current position, a velocity, a behavior of a passenger of the vehicle, etc.

Although the case in which the compressibility of the information concerning the traveling state is changed is explained, upon receipt of an execution instruction for other processing, the information recording apparatus 1400 may change a record retaining period for retaining the information concerning the traveling state. Since the information concerning the traveling state is continuously recorded, the information increases as time elapses, and an occupied amount of the recording medium also increases. Therefore, the information after a predetermined retaining period is sequentially deleted. An area of the recording medium to be used for executing other processing can be secured by changing (specifically, shortening) the record retaining period.

In this case, when the receiving unit 1401 receives an execution instruction for other processing while the recording processing is in progress, the setting unit 1402 sets the record retaining period for retaining the information concerning the traveling state to be shorter than that before the execution instruction for the other processing. The control unit 1403 controls the recording processing to be executed using the record retaining period set by the setting unit 1402.

When the receiving unit 1401 receives the execution instruction for the other processing while the recording processing is in progress, the calculating unit 1404 calculates the total amount of data that would occupy the recording-medium in the event that the recording processing and the other processing are executed simultaneously. This total data amount is a sum of the amount of the information concerning the traveling state corresponding to the record retaining period and the amount of information for the other processing. The judging unit 1405 judges whether the total data amount calculated by the calculating unit 1404 exceeds a predetermined amount. The explanation of the flowchart of FIG. 15 is obtained by replacing the “compressibility” with the “record retaining period.”

As explained above, according to the information recording apparatus 1400 of embodiment 2, upon receipt of an execution instruction for other processing while the information concerning the traveling state is being recorded, a compressibility of the information concerning the traveling state or a record retaining period for retaining the information is changed. As a result, the other processing can be executed by appropriately using the limited recording medium of the information recording apparatus 1400 without stopping the recording processing of the information concerning the traveling state.

When the compressibility or the record retaining period is changed, the compressibility or the record retaining period is set based on the total data amount required for the recording processing and the other processing. As a result, when the compressibility or the record retaining period need not be changed, for example, when the recording-medium occupied amount required for the other function is small, the other processing can be executed without changing the compressibility or the record retaining period.

When the other processing is complete, the compressibility or the record retaining period is reset to that before the execution instruction for the other processing, constantly maintaining the quality of the information concerning the traveling state. When the recording processing and the other processing cannot be simultaneously executed at any compressibility or using any record retaining period, either processing is stopped. As a result, each processing can be effectively executed by using the limited recording medium of the information recording apparatus 1400.

### Example 3

Examples of the information recording apparatus 1400 according to embodiment 2 explained above are explained. Similar to examples 1 and 2 according to embodiment 1, for examples 3 and 4 according to embodiment 2, hereinafter, a case in which the information recording apparatus 1400 is applied to the navigation apparatus 400 is explained. Since the peripheral devices of the navigation apparatus 400 and the hardware configuration of the navigation apparatus 400 are identical to those in examples 1 and 2, explanation thereof is omitted.

The data recorded by the drive recording function of the navigation apparatus 400 according to examples 3 and 4 are overwritten sequentially from old data while a predetermined interval of the newest data is retained since the memory amount of the navigation apparatus 400 has an upper limit. Therefore, when the data storing interval and the compressibility of images are constant, the data stored by the drive recording function always occupies a predetermined area of the memory.

The navigation apparatus 400 has various functions such as playback of a DVD or a CD, receiving/recording of a TV broadcast, connection to the Internet. Similar to the drive recording function, these functions are executed using a memory area of the navigation apparatus 400. Therefore, when other processing is attempted to be executed while the drive recording function is in progress, the memory might be insufficient, and the drive recording function must be stopped in such a case. On the other hand, since the drive recording function is for recording an accident, which can occur at any time, it is preferable to continue the drive recording operation as long as possible.

In such a case, the navigation apparatus 400 adjusts the compressibility of the drive recording function, and reduces the occupancy of the memory for the drive recording function. As a result, the drive recording operation can be continued as long as possible, and the other function of the navigation apparatus 400 can be simultaneously executed.

In the functional configuration of the information recording apparatus 1400 according to embodiment 2, the function of the receiving unit 1401 is implemented by the input device 511, and functions of the setting unit 1402, the control unit 1403, the calculating unit 1404, and the judging unit 1405 are implemented by the CPU 501.

### (Compressibility Change Processing of Navigation Apparatus 400)

Compressibility change processing of the navigation apparatus 400 is explained. As explained above, the memory might be insufficient when the navigation apparatus 400 simultaneously executes the drive recording function and another function. In this case, the navigation apparatus 400 changes the compressibility (resolution) of images to be recorded to reduce the memory required for the drive recording function. As a result, the insufficient memory can be covered, and the other function can be executed without stopping the drive recording function.

In the drive recording function, the amount of memory required for recording images captured by the onboard camera 411 differs according to resolution and shooting range of images to be recorded, screen size (i.e., an amount of source image data), the kind and compressibility of an image compressing codec, etc. For example, if the images shot by the onboard camera 411 are recorded at a compressibility increased to the degree that the subject can be identified (in terms of the drive recording function, the image is admissible as evidence), the amount of data to be recorded decreases, and the required amount of memory can be reduced.

On the other hand, when setting the compressibility too high, the resolution of the captured image deteriorates, and a subject may not be identifiable. Therefore, the navigation apparatus 400 typically records the captured images without compression to enhance the evidential potential of the images in the event of an accident.

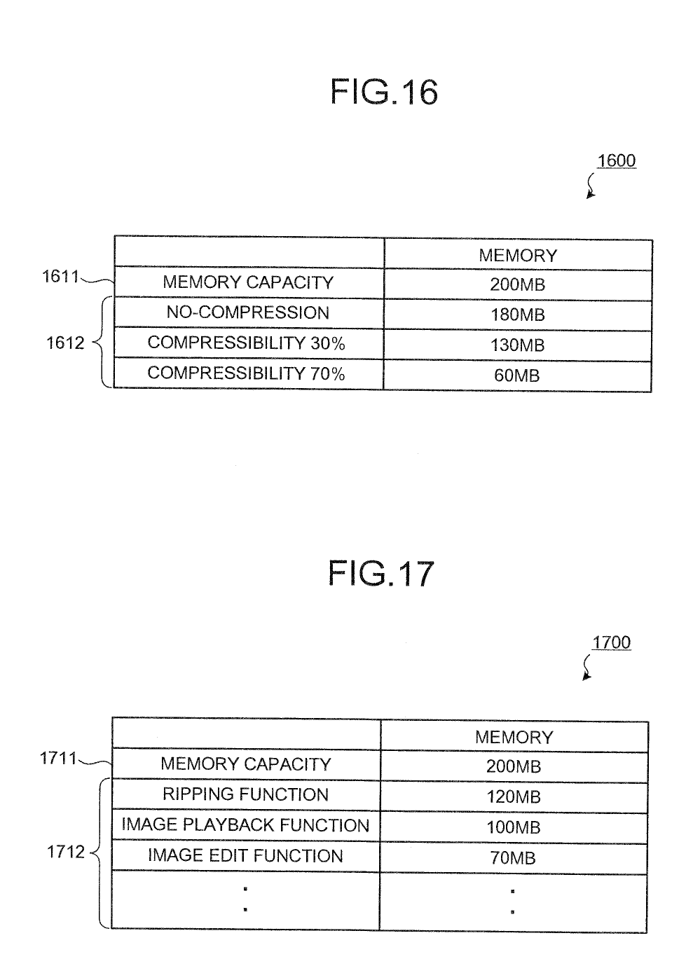

FIG. 16 is a chart of examples of required memory amounts according to compressibility. A table of required memory amounts for each compressibility (hereinafter, compressibility-memory table) 1600 includes memory capacity 1611 indicating the capacity of a memory and a required memory amount for each compressibility 1612. In the example shown, the memory capacity 1611 is 200 MB.

A percentage of the compressibility indicates an amount of data after compression where the amount of data before the compression is 100%. For example, data after the compression is 30 MB when data of 100 MB is compressed at the compressibility of 70%, and 70 MB when the data is compressed at the compressibility of 30%. Therefore, the higher the percentage of the compressibility is, the higher the compressibility is.

The required memory amount for each compressibility 1612 is a memory amount when compressing the image data of a predetermined interval at a corresponding compressibility. In the example shown, the memory amount is 180 MB when compression is not executed, 130 MB when the compressibility is 30%, and 60 MB when the compressibility is 70%. The higher the compressibility is, the less the required memory amount is.

FIG. 17 is a chart of examples of required memory amounts according to function. A table of required memory amounts for each function (hereinafter, “function-memory table”) 1700 includes memory capacity 1711 indicating the capacity of a memory, and a required memory amount for each function 1712. In the example shown, similar to FIG. 5, the memory capacity 1711 is 200 MB. The required memory amount for each function 1712 is 120 MB for a ripping function as an example of the function, 100 MB for an image playback function, and 70 MB for an image edit function.

The navigation apparatus 400 stores the compressibility-memory table 1600 and the function-memory table 1700, and changes a compressibility of image data to secure a memory area required for other processing when an execution instruction for another function is received while the drive recording function is in progress. Hereinafter, compressibility change processing executed by the navigation apparatus 400 is explained in detail.

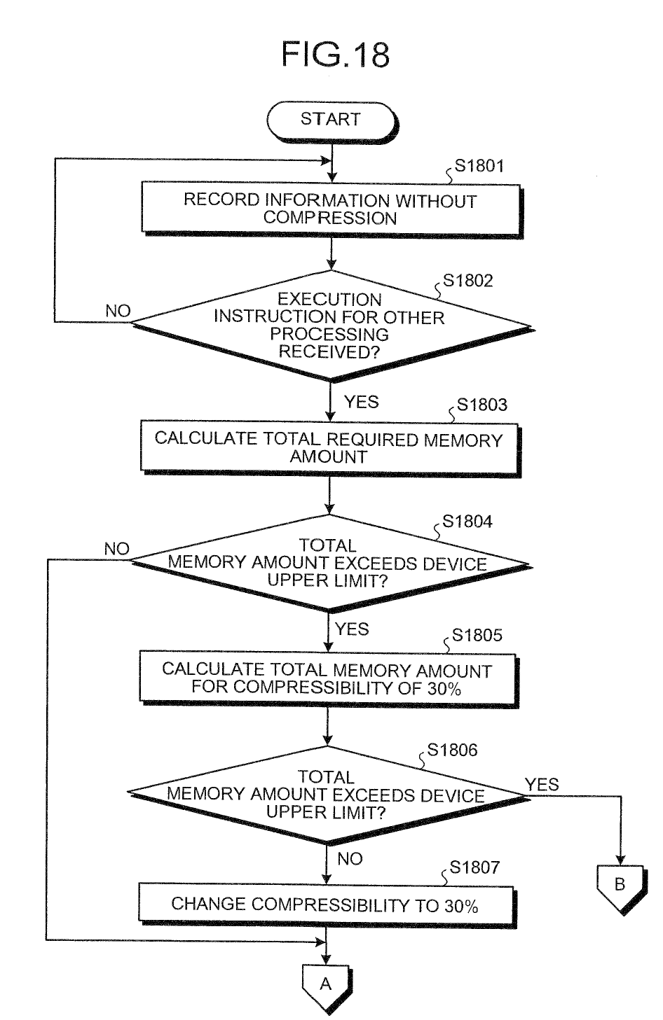

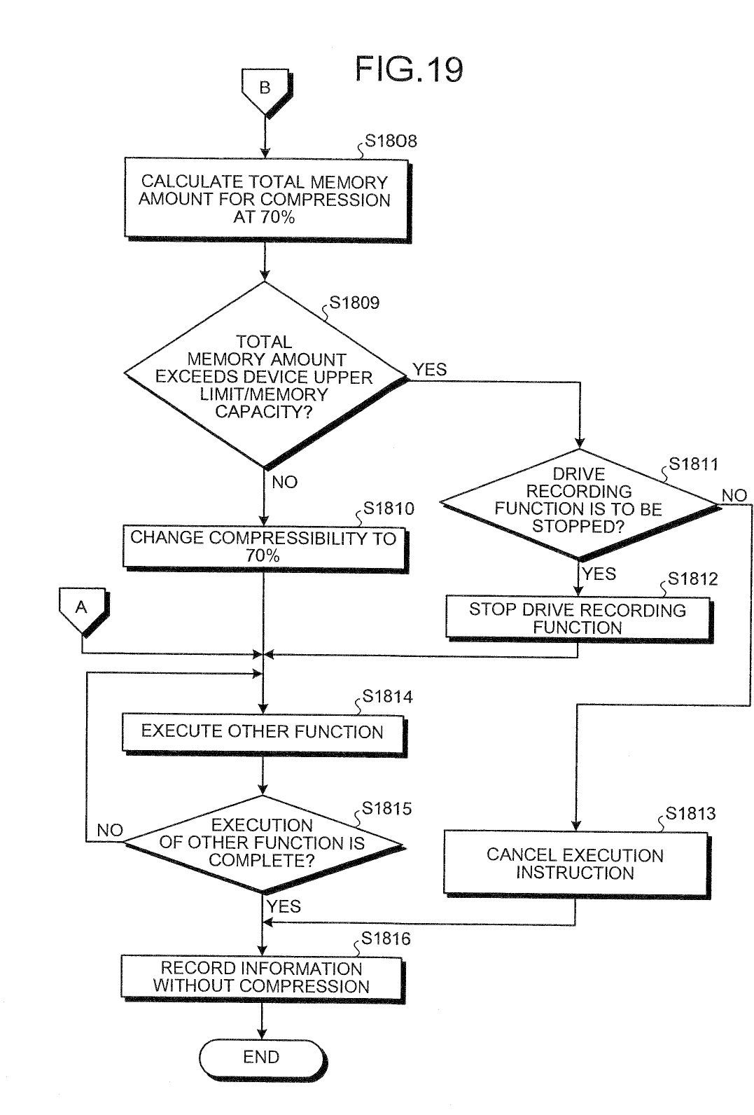

FIGS. 18 and 19 are flowcharts of compressibility change processes executed by the navigation apparatus. As shown in the flowchart of FIG. 18, the navigation apparatus 400 is processing and recording the image data captured by the onboard camera 411 without compression through the DSP 517 (step S1801). It is judged through the input device 511 whether an execution instruction for another function has been received (step S1802). An execution instruction for another function may be initiated by a passenger of the vehicle, or automatically initiated according to the traveling state of the vehicle.

When an execution instruction for another function has not been received (step S1802: NO), the process returns to step S1801, and the recording continues without compression. On the contrary, when an execution instruction for another function has been received (step S1802: YES), a total memory amount required for the simultaneous execution of the drive recording function and the other function is calculated (step S1803). Specifically, for example, when the execution instruction for the image playback function as the other function is received, the memory amount of 70 MB required for the image playback function (see FIG. 17) and the memory amount of 180 MB required for the recording without compression (see FIG. 16) are added. As a result, the total memory amount is 250 MB.

It is judged whether the calculated total memory amount exceeds the memory capacity (step S1804). For example, in the example shown in FIG. 16, the memory capacity 1611 is 200 MB, and the total memory amount of 260 MB required for simultaneous execution of the drive recording function and the image playback function exceeds the memory capacity.

When the total memory amount does not exceed the memory capacity (step S1804: NO), the process proceeds to step S1814 in FIG. 19. In contrast, when the total memory amount exceeds the memory capacity (step S1804: YES), a total memory amount when the compressibility is switched to 30% is calculated (step S1805). In this case, the memory amount of 130 MB required for recording at the compressibility of 30% (see FIG. 16) and the memory amount of 70 MB required for the image playback function are added, and the total memory amount is 200 MB.

It is judged whether the calculated total memory amount exceeds the memory capacity (step S1806). For example, in the above case, the calculated total memory amount of 200 MB does not exceed the memory capacity. When the calculated total memory amount does not exceed the memory capacity (step S1806: NO), the compressibility of image data is changed to 30% (step S1807), and the process proceeds to step S1814 in FIG. 19. On the contrary, when the calculated total memory amount exceeds the memory capacity (step S1806: YES), the process proceeds to step S1808 in FIG. 19.

As shown in FIG. 19, when the calculated total memory amount exceeds the memory capacity (step S1806: YES), a total memory amount for a compression of 70% (step S1808) is calculated. In this case, the memory amount of 60 MB required for the recording at the compressibility of 70% (see FIG. 16) and the memory amount required for the other function instructed at step S1802 are added.

It is judged whether the calculated total memory amount exceeds the memory capacity (step S1809). When the calculated total memory amount does not exceed the memory capacity (step S1809: NO), the compressibility of the image data is changed to 70% (step S1810), the process proceeds to step S1814. On the contrary, when the calculated total memory amount exceeds the memory capacity (step S1809: YES), it is judged whether the drive recording function is to be stopped (step S1811). For example, this judgment is executed by causing the display 513 to display a confirmation message and causing a user to make a selection.

When the drive recording function is to be stopped (step S1811: YES), the drive recording function is stopped (step S1812), the process proceeds to step S1814. As a result, a memory amount required for the drive recording function becomes zero, memory areas for executing the other processing do not become insufficient. When the drive recording function is not to be stopped (step S1811: NO), the execution instruction for the other function is cancelled (step S1813), and the process proceeds to step S1816.

When the compressibility is changed at steps S1807 or S1810, or when the drive recording function is stopped at step S1812, the other processing instructed at step S1802 is executed (step S1814). The DSP 517 continues to record image data even while executing the other processing except when the drive recording function is stopped at step S1812. Until execution of the other function is complete (step S1815: NO), the process returns to step S1814, and the other function continues to be executed.

When the execution of the other function is complete (step S1815: YES), image data is recorded without compression (step S1816), the processing ends. At this time, when the drive recording function is stopped at step S1812, execution of the drive recording function is restarted, and the recording is executed without compression. When the compressibility is changed at steps S1807 and S1810, the compressibility is changed to the original compressibility of no-compression, and the recording is executed. When the total memory amount does not exceed the memory capacity at step S1804, or when the execution instruction for the other function is cancelled at step S1813, since the recording continues without compression, the recording processing is continues as is.

Although the case in which the compressibility is changed is explained above, a shooting range of the onboard camera 411 or a screen size may be adjusted. Specifically, for example, the shooting range and the screen size are reduced. As a result, there may be no need to change the compressibility. Alternatively, the kind of the codec may be changed. When an execution instruction for another function is given for plural functions, a total memory amount required for executing each function and recording at each compressibility are calculated at steps S1803, S1805, and S1808.

As explained above, according to the navigation apparatus 400 of example 3, upon receiving an execution instruction for another function while the drive recording function is in progress, the compressibility of the drive recording function is changed to be higher. As a result, the other processing can be executed without stopping the drive recording function by appropriately using the limited memory of the navigation apparatus 400.

### Example 4

The navigation apparatus 400 according to example 3 secures a memory area required for executing other processing by changing the compressibility of image data to be recorded. The navigation apparatus 400 according to example 4 secures a memory area required for executing other processing by changing a data storing interval (retaining period) for retaining recorded images data.

As explained above, since the memory amount of the navigation apparatus 400 has an upper limit, the data recorded by the drive recording function is sequentially overwritten from old data with latest data for a predetermined interval remaining. As a result, when the storing interval of data and the compressibility of images are constant, the data recorded by the drive recording function always occupies a predetermined area of the memory. When the memory area is insufficient upon execution of the other function, the navigation apparatus 400 according to example 4 secures a memory area required for executing the other function by changing the storing interval of data.

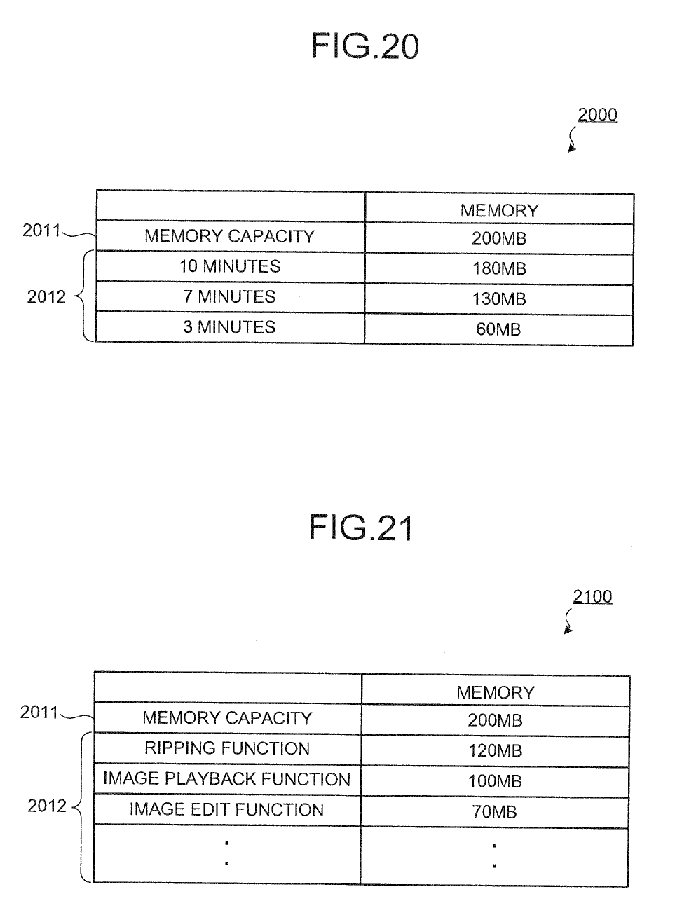

FIG. 20 is a chart of examples of required memory amounts according to data storing intervals. A table of required memory amounts for each data storing interval (hereinafter, “storing interval-memory table”) 2000 includes memory capacity 2011 indicating the capacity of a memory, and a required memory amount for each storing interval for storing the recorded data 2012. In the example shown, the memory capacity 2011 is 200 MB similar to example 3. The required memory amount for each data storing interval 2012 is 180 MB for 10 minutes, 130 MB for 7 minutes, and 60 MB for 3 minutes.

FIG. 21 is a chart of examples of required memory amounts according to function. A table of required memory-amounts for each function (hereinafter, “function-memory table”) 2100 includes memory capacity 2111 indicating the capacity of a memory, and a memory amount required for executing each function 2122. In the example shown, the memory capacity 2111 is 200 MB similar to FIG. 20. For example, the memory amount for each function 2112 is 120 MB for a ripping function as an example of the function, 100 MB for an image playback function, and 70 MB for an image edit function.

The navigation apparatus 400 stores the storing interval-memory table 2000 and the function-memory table 2100, and changes an interval for storing data to secure a memory area required for another function upon receipt of an execution instruction for another function during execution of the drive recording function. Hereinafter, data-storing-interval change processing executed by the navigation apparatus 400 is explained.

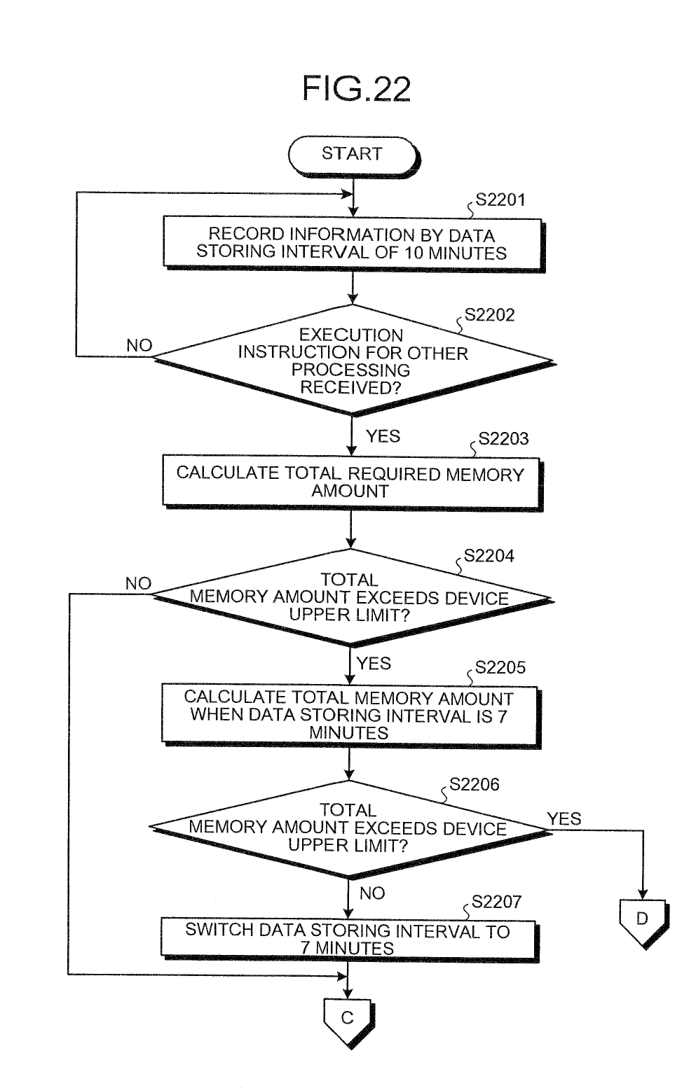

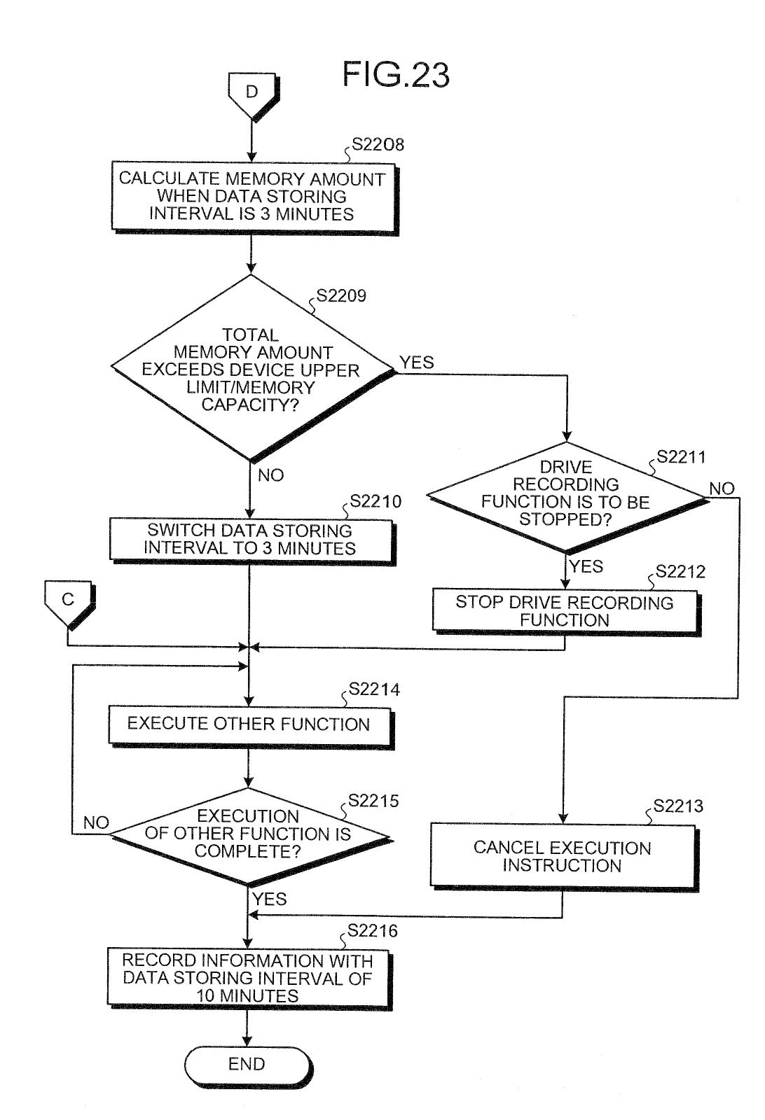

FIGS. 22 and 23 are flowcharts of the data-storing-interval-change processes executed by the navigation apparatus. As shown in the flowchart of FIG. 22, the navigation apparatus 400 is recording the image data captured by the onboard camera 411 by a data storing interval of 10 minutes (step S2201). It is judged through the input device 511 whether an execution instruction for another function has been received (step S2202). An execution instruction for another function may be initiated by a passenger of the vehicle, or automatically initiated according to the traveling state of the vehicle.

When an execution instruction for another function has not been received (step S2202: NO), the process returns to step S2201, and recording continues with the storing interval of 10 minutes. On the contrary, when the execution instruction for another function has been received (step S2202: YES), a total memory amount required for simultaneous execution of the drive recording function and the other function is calculated (step S2203). Specifically, for example, when the image edit function is instructed as the other function, a memory amount of 70 MB required for executing the image edit function (see FIG. 21), and a memory amount of 180 MB required for the recording by the data storing interval of 10 minutes (see FIG. 20) are added.

It is judged whether the calculated total memory amount exceeds the memory capacity (step S2204). For example, in the case of the image edit function and the recording by the storing interval of 10 minutes, the total required memory amount is 250 MB, which exceeds the memory capacity of 200 MB.

When the total memory amount does not exceed the memory capacity (step S2204: NO), the process proceeds to step S2214 in FIG. 23. When the total memory amount exceeds the memory capacity (step S2204: YES), a total memory amount in the case of a data storing interval of 7 minutes is calculated (step S2205). In this case, the memory amount of 130 MB in the case of the data storing interval of 7 minutes (see FIG. 20) and the memory amount of 70 MB required for the image edit function are added.

It is judged whether the calculated total memory amount exceeds the memory capacity (step S2206). For example, in the case of the image edit function and the recording by the data storing interval of 7 minutes, the total required memory amount is 200 MB, which does not exceed the memory capacity. When the total memory amount does not exceed the memory capacity (step S2206: NO), the data storing interval is changed to 7 minutes (step S2207), and the process proceeds to step S2214 in FIG. 23. On the contrary, when the total memory amount exceeds the memory capacity (step S2206: YES), the process proceeds to step S2208 in FIG. 23.

As shown in FIG. 23, when the total memory amount exceeds the memory capacity (step S2206: YES), a total memory amount in the case of a data storing interval of 3 minutes is calculated (step S2208). In this case, the memory amount of 60 MB required in the case of the data storing interval of 3 minutes (see FIG. 20) and the memory amount required for the function instructed at step S2202 (see FIG. 21) are added.

It is judged whether the calculated total memory amount exceeds the memory capacity (step S2209). When the calculated total memory amount does not exceed the memory capacity (step S2209: NO), the data storing interval is changed to 3 minutes (step S2210), the process proceeds to step S2214. On the contrary, when the calculated total memory amount exceeds the memory capacity (step S2209: YES), it is judged whether the drive recording function is to be stopped (step S2211). For example, this judgment is executed by causing the display 513 to display a confirmation message and causing a user to make a selection.

When the drive recording function is to be stopped (step S2211: YES), the drive recording function is stopped (step S2212), the process proceeds to step S2214. As a result, the total memory amount required for the drive recording function becomes zero, the total memory amount for executing the other function does not become insufficient. On the contrary, when the drive recording function is not to be stopped (step S2211: NO), the execution instruction for the other function is cancelled (step S2213), and the process proceeds to step S2216.

Priorities of the drive recording function and the other function may preliminarily set to decide which function is to be stopped based on the priorities. In this case, the priorities may be arbitrarily set by a user or by the navigation apparatus 400 according to the traveling state such as whether a current position of the vehicle is at a point such as an intersection where an accident is likely to occur, whether a continuous driving period of time is greater than a predetermined period of time, or whether a velocity is greater than a predetermined velocity.

When the data storing interval is changed at step S2207 or S2210, or when the drive recording function is stopped at step S2212, the other function instructed at step S2202 is executed (step S2214). The DSP 517 continues to record image data except when the drive recording function is stopped at step S2212. Until execution of the other function is complete (step S2215: NO), the process returns to step S2214, and the other function continues to be executed.

When the execution of the other function is complete (step S2215: YES), image data is recorded by the data storing interval of 10 minutes as before receipt of the execution instruction for the other processing (step S2216), the processing ends. At this time, when the drive recording function is stopped at step S2212, execution of the drive recording function is restarted. When the data storing interval is changed at steps S2207 or S2210, the data storing interval is changed to the original data storing interval of 10 minutes. When the total memory amount does not exceed the memory capacity at step S2204, or when the execution instruction for the other function is cancelled at step S2213, since the recording is being continued by the data storing interval of 10 minutes, the recording processing continues as is.

Similar to example 3, a shooting range of the onboard camera 411 or a screen size may be adjusted such that the consumed memory amount is reduced. Specifically, for example, the shooting range and the screen size are reduced. As a result, there may be no need to change the data storing interval. When an execution instruction for another function is given for plural functions, a total memory amount required for executing each function and recording by each data storing interval are calculated at steps S2203, S2205, and S2208.

As explained above, the navigation apparatus 400 according to examples 3 and 4, upon receipt of an execution instruction for another function during execution of the drive recording function, a compressibility of the drive recording function or a data storing interval is changed. As a result, the other function can be executed without stopping the drive recording function by appropriately using limited memory areas of the navigation apparatus 400.

When the compressibility or the data storing interval is changed, compressibility or a data storing interval is set based on the total memory amount required for the recording processing and the other processing. As a result, when the compressibility or the data storing interval need not be changed, for example, when the memory amount required for the other function is small, the other function can be executed without changing the compressibility or the data storing interval. When the execution of the other function is complete, the compressibility or the data storing interval is reset to that before the execution instruction for the other function, constantly maintaining the quality of the recorded data.

When the recording function and the other function cannot be simultaneously executed at any compressibility or by any data storing interval, either of the functions is stopped. As a result, each function can be effectively executed by using the limited memory area of the information recording apparatus. Particularly, when the memory area is insufficient for executing both functions, the functions are appropriately switched and executed by assigning priorities to each of the functions.

The information recording method explained in the present embodiment can be implemented by a computer such as a personal computer and a workstation executing a program that is prepared in advance. This program is recorded on a computer-readable recording medium such as a hard disk, a flexible disk, a CD-ROM, an MO, and a DVD, and is executed by being read out from the recording medium by a computer. This program can be a transmission medium that can be distributed through a network such as the Internet.

1-23. (canceled)

24. An information recording apparatus that executes recording processing for information concerning a traveling state of a mobile object, the information recording apparatus comprising:
a receiving unit that receives an execution instruction for other processing;
a setting unit that, upon the receiving unit receiving the execution instruction while the recording processing is in progress, sets a compressibility of the information to be lower than that before receipt of the execution instruction; and
a control unit that controls the recording processing to be executed at the compressibility set by the setting unit.

25. The information recording apparatus according to claim 24, further comprising
a calculating unit that, upon the receiving unit receiving the execution instruction while the recording processing is in progress, calculates a total resource amount indicative of performance when the recording processing and the other processing are executed simultaneously, wherein
the setting unit sets, based on the total resource amount, the compressibility to be lower than that before the receipt of the execution instruction.

26. The information recording apparatus according to claim 24, wherein the setting unit, when the other processing is complete, sets the compressibility to be higher than that during execution of the other processing.

27. An information recording apparatus that uses a codec selected from among a plurality of codecs, each requiring a different resource amount and derived from a processing algorithm, to execute recording processing for information concerning a traveling state of a mobile object, the information recording apparatus comprising:
a receiving unit that receives an execution instruction for other processing;
a calculating unit that calculates, upon the receiving unit receiving the execution instruction while the recording processing is in progress, a total resource amount required for execution of the other processing and the codec currently used for the recording processing;
a setting unit that sets, based on the total resource amount, the codec for use during the other processing; and
a control unit that controls the recording processing to be executed using the codec set by the setting unit.

28. The information recording apparatus according to claim 27, further comprising
a judging unit that judges whether the total resource amount is equal to or greater than a predetermined amount, wherein
the setting unit sets the codec for use during the other processing, based on a judgment result by the judging unit.

29. The information recording apparatus according to claim 28, wherein
the calculating unit calculates newly, upon the judging unit judging that the total resource amount is equal to or greater than the predetermined amount, the total resource amount required for the execution of the other processing and the codec that is set by the setting unit and different from the codec currently being used, and
the judging unit judges whether the total resource amount calculated newly is equal to or greater than the predetermined amount.

30. The information recording apparatus according to claim 27, wherein the control unit stops the recording processing or the other processing when no codec is set by the setting unit.

31. An information recording apparatus that executes recording processing for information concerning a traveling state of a mobile object, the information recording apparatus comprising:
a receiving unit that receives an execution instruction for other processing;
a setting unit that, upon the receiving unit receiving the execution instruction while the recording processing is in progress, sets a compressibility of the information to be higher than that before receipt of the execution instruction; and
a control unit that controls the recording processing to be executed at the compressibility set by the setting unit.

32. The information recording apparatus according to claim 31, further comprising
a calculating unit that, upon the receiving unit receiving the execution instruction while the recording processing is in progress, calculates a total data amount resulting from the information being compressed at the compressibility used before the receipt of the execution instruction and execution of the other processing, wherein
the setting unit sets, based on the total data amount, the compressibility to be higher than that before the receipt of the execution instruction.

33. The information recording apparatus according to claim 32, further comprising
a judging unit that judges whether the total data amount is equal to or greater than a predetermined amount, wherein
the setting unit sets, based on a judgment result by the judging unit, the compressibility to be higher than that before the receipt of the execution instruction.

34. The information recording apparatus according to claim 33, wherein
the calculating unit calculates newly the total data amount resulting from the information being compressed at the compressibility set by the setting unit and the execution of the other processing, and
the judging unit judges whether the total data amount calculated newly is equal to or greater than the predetermined amount.

35. The information recording apparatus according to claim 31, wherein the control unit controls the recording processing or the other processing to stop when no compressibility is set by the setting unit.

36. An information recording apparatus that executes recording processing for information concerning a traveling state of a mobile object, the information recording apparatus comprising:
a receiving unit that receives an execution instruction for other processing;
a setting unit that, upon the receiving unit receiving the execution instruction while the recording processing is in progress, sets a record retaining period to be shorter than that before receipt of the execution instruction; and
a control unit that controls the recording processing to be executed using the record retaining period set by the setting unit.

37. The information recording apparatus according to claim 36, further comprising
a calculating unit that, upon the receiving unit receiving the execution instruction while the recording processing is in progress, calculates a total data amount resulting from the information being retained for the record retaining period used before the receipt of the execution instruction and execution of the other processing, wherein
the setting unit sets, based on the total data amount, the record retaining period to be shorter than that before the receipt of the execution instruction.

38. The information recording apparatus according to claim 37, further comprising
a judging unit that judges whether the total data amount is equal to or greater than a predetermined amount, wherein
the setting unit sets, based on a judgment result by the judging unit, the record retaining period to be shorter than that before the receipt of the execution instruction.

39. The information recording apparatus according to claim 38, wherein
the calculating unit calculates newly the total data amount resulting from the information being retained for the record retaining period set by the setting unit and the execution of the other processing, and
the judging unit judges whether the total data amount calculated newly is equal to or greater than the predetermined amount.

40. The information recording apparatus according to claim 36, wherein the control unit controls the recording processing or the other processing to stop when no record retaining period is set by the setting unit.

41. An information recording method of executing recording processing for information concerning a traveling state of a mobile object, the information recording method comprising:
receiving an execution instruction for other processing;
setting, upon receipt of the execution instruction at the receiving while the recording processing is in progress, a compressibility of the information to be lower than that before the receipt of the execution instruction; and
controlling the recording processing to be executed at the compressibility set at the setting.

42. An information recording method of using a codec selected from among a plurality of codecs, each requiring a different resource amount and derived from a processing algorithm, to execute recording processing for information concerning a traveling state of a mobile object, the information recording method comprising:
receiving an execution instruction for other processing;
calculating, upon receipt of the execution instruction at the receiving while the recording processing is in progress, a total resource amount required for execution of the other processing and the codec currently used for the recording processing;
setting, based on the total resource amount, the codec for use during the other processing; and
controlling the recording processing to be executed using the codec set by the setting unit.

43. An information recording method of executing recording processing for information concerning a traveling state of a mobile object, the information recording method comprising:
receiving an execution instruction for other processing;
setting, upon receipt of the execution instruction at the receiving while the recording processing is in progress, a compressibility of the information to be higher than that before the receipt of the execution instruction; and
controlling the recording processing to be executed at the compressibility set by the setting unit.

44. An information recording method of executing recording processing for information concerning a traveling state of a mobile object, the information recording method comprising:
receiving an execution instruction for other processing;
setting, upon receipt of the execution instruction at the receiving while the recording processing is in progress, a record retaining period to be shorter than that before the receipt of the execution instruction; and
controlling the recording processing to be executed using the record retaining period set by the setting unit.

45. A recording medium storing therein a computer program that is for executing recording processing for information concerning a traveling state of a mobile object and causes a computer to execute:
receiving an execution instruction for other processing;
setting, upon receipt of the execution instruction at the receiving while the recording processing is in progress, a compressibility of the information to be lower than that before the receipt of the execution instruction; and
controlling the recording processing to be executed at the compressibility set at the setting.

46. A recording medium storing therein a computer program that is for using a codec selected from among a plurality of codecs, each requiring a different resource amount, to execute recording processing for information concerning a traveling state of a mobile object and causes a computer to execute:
receiving an execution instruction for other processing;
calculating, upon receipt of the execution instruction at the receiving while the recording processing is in progress, a total resource amount required for execution of the other processing and the codec currently used for the recording processing;
setting, based on the total resource amount, the codec for use during the other processing; and
controlling the recording processing to be executed using the codec set by the setting unit.

47. A recording medium storing therein a computer program that is for executing recording processing for information concerning a traveling state of a mobile object and causes a computer to execute:
receiving an execution instruction for other processing;
setting, upon receipt of the execution instruction at the receiving while the recording processing is in progress, a compressibility of the information to be higher than that before the receipt of the execution instruction; and
controlling the recording processing to be executed at the compressibility set by the setting unit.

48. A recording medium storing therein a computer program this is for executing recording processing for information concerning a traveling state of a mobile object and causes a computer to execute:
receiving an execution instruction for other processing;
setting, upon receipt of the execution instruction at the receiving while the recording processing is in progress, a record retaining period to be shorter than that before the receipt of the execution instruction; and
controlling the recording processing to be executed using the record retaining period set by the setting unit.
